(19) United States
(12) Patent Application Publication
(10) Pub. No.: US 2026/0121802 A1
(43) Pub. Date: Apr. 30, 2026

(54) CROSS-COMPONENT CARRIER JOINT BEAM REPORTING

(71) Applicant: QUALCOMM Incorporated, San Diego, CA (US)

(72) Inventors: Hyojin LEE, San Diego, CA (US); Yan ZHOU, San Diego, CA (US); Jing JIANG, San Diego, CA (US)

(21) Appl. No.: 18/931,420

(22) Filed: Oct. 30, 2024

(51) Int. Cl. H04L 5/00

(52) U.S. Cl. CPC H04L 5/001; H04L 5/0051; H04L 5/0091

(57) ABSTRACT

Various aspects of the present disclosure generally relate to wireless communication. In some aspects, a network node may transmit a reference signal (RS) resource set configuration that indicates RS resource linkages between a first RS resource set for a first component carrier, and a second RS resource set for a second component carrier. Each RS resource linkage may be between a first RS resource in the first RS resource set and a second RS resource in the second RS resource set. Each RS resource linkage may be associated with a respective common RS transmit beam. The network node may transmit a report configuration that indicates: an RS resource set linkage between the first RS resource set and the second RS resource set, and an instruction to perform cross-component carrier joint beam reporting using the RS resource set linkage and a common RS transmit beam. Numerous other aspects are described.

### FIELD OF THE DISCLOSURE

Aspects of the present disclosure generally relate to wireless communication and specifically relate to techniques, apparatuses, and methods associated with cross-component carrier joint beam reporting.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a network node. The method may include transmitting a reference signal (RS) resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The method may include transmitting a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to a method of wireless communication performed by a user equipment (UE). The method may include receiving an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The method may include receiving a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to an apparatus for wireless communication at a network node. The apparatus may include one or more memories and one or more processors coupled to the one or more memories. The one or more processors may be configured, individually or collectively, to transmit an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The one or more processors may be configured, individually or collectively, to transmit a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to an apparatus for wireless communication at a UE. The apparatus may include one or more memories and one or more processors coupled to the one or more memories. The one or more processors may be configured, individually or collectively, to receive an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The one or more processors may be configured, individually or collectively, to receive a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to a non-transitory computer-readable medium that stores a set of instructions for wireless communication by a network node. The set of instructions, when executed by one or more processors of the network node, may cause the network node to transmit an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The set of instructions, when executed by one or more processors of the network node, may cause the network node to transmit a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to a non-transitory computer-readable medium that stores a set of instructions for wireless communication by a UE. The set of instructions, when executed by one or more processors of the UE, may cause the UE to receive an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The set of instructions, when executed by one or more processors of the UE, may cause the UE to receive a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to an apparatus for wireless communication. The apparatus may include means for transmitting an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The apparatus may include means for transmitting a report configuration that indicates an RS resource set linkage between the first RS resource set and the second RS resource set, and an instruction to perform cross-component carrier joint beam reporting based at least in part on the RS resource set linkage and the one or more common RS transmit beams.

Some aspects described herein relate to an apparatus for wireless communication. The apparatus may include means for receiving an RS resource set configuration that indicates one or more RS resource linkages between a first RS resource set that is associated with a first component carrier, and a second RS resource set that is associated with a second component carrier. A respective RS resource linkage of the one or more RS resource linkages may indicate an association between at least a first respective RS resource in the first RS resource set and a second respective RS resource in the second RS resource set, and the respective RS resource linkage may be associated with a respective common RS transmit beam of one or more common RS transmit beams. The apparatus may include means for receiving a report configuration that indicates an RS resource set linkage between the first RS resource set and the second RS resource set, and an instruction to perform cross-component carrier joint beam reporting based at least in part on the RS resource set linkage and the one or more common RS transmit beams.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a bandwidth part (BWP), in accordance with the present disclosure.

FIG. 4 is a diagram illustrating an example of BWP channel feedback, in accordance with the present disclosure.

FIGS. 5A, 5B, and 5C are diagrams illustrating a first example, a second example, and a third example, respectively, of cross-component carrier joint beam reporting messaging, in accordance with the present disclosure.

FIG. 6 is a diagram illustrating an example of a wireless communication process between a network node and a user equipment (UE), in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication channel, alternatively referred to as a “carrier”, may be based at least in part on a center frequency, a frequency bandwidth, and or a set of resource blocks (RBs). To illustrate, a carrier may be based at least in part on a center frequency (e.g., a carrier frequency) and a frequency bandwidth. Each RB of the carrier may include a group of resource elements (REs) that are characterized by a frequency partition and a time partition. Accordingly, the set of RBs associated with the carrier may collectively span a bandwidth and time duration. A component carrier is an individual carrier that may be integrated with other carriers through carrier aggregation.

A bandwidth part (BWP) may be characterized as a subset of contiguous RBs (and/or REs) within the set of RBs associated with a carrier, and a carrier may be partitioned into multiple BWPs. The ability to partition the carrier into BWPs may provide flexibility and efficient usage of the bandwidth associated with the carrier. To illustrate, a network node may configure a carrier with a frequency bandwidth that spans 100 megahertz (MHz), which may also be referred to as a wideband channel, and some user equipments (UEs) serviced by the network node may lack capabilities that support wideband communications. For example, a UE implemented as an Internet of Things (IoT) device may lack a transceiver with capabilities to transmit and/or receive a wideband signal. Accordingly, a network node may partition a carrier into one or more BWPs for communicating with the IoT device and/or other types of UEs. In some cases, the network node may configure a UE with multiple component carriers, such as in a first case to increase data throughput, in a second case to enable efficient spectrum usage, and/or in a third case to balance traffic loads across different frequency bands.

Alternatively, or additionally, the network node 110 may configure the UE to generate and report respective measurement metrics for each BWP, such as channel state information (CSI), that enables the network node to schedule and/or manage resources in an efficient and/or optimized manner. As an example of efficient and/or optimized scheduling, the network node may select a beam configuration, a modulation and coding scheme (MCS), precoding, and/or an active BWP that increases data throughput, reduces data recovery errors, and/or reduces data transfer latencies in a wireless network. Because each BWP associated with the UE may experience different channel conditions, the network node may configure the UE to report respective measurement metrics for each BWP (e.g., BWP-specific CSI), and the BWP-specific measurement metrics may enable the network node to optimize scheduling specific to a BWP and/or change the active BWP to a different BWP in a manner that increases data throughput, reduces data recovery errors, and/or reduces data transfer latencies. However, BWP-specific reporting and/or component carrier-specific reporting may lead to inefficient signaling overhead that results in decreased data throughput and/or increased data transfer latencies in a wireless network.

For instance, a network node may include a select number of transmit-receive units (TXRUs) (e.g., fewer than four (4)), and each TXRU may include, or be connected to, a substantial number of antenna elements (e.g., 64 or greater antenna elements). To achieve a high equivalent isotropic radiated power (EIRP) level, the network node may rely upon primarily on analog beamforming in which each antenna element amplifies the same signal, resulting in an increase to a power level of the output signal. In some scenarios, a single TXRU included in a network node may support multiple component carriers using a common analog beam. For example, in a first scenario, the network node may contemporaneously support eight (8) component carriers using 4 TXRUs such that at least two component carriers are supported by the network node using a same TXRU and a common analog beam. Although a single TXRU may manage multiple component carriers based at least in part on using a common analog beam, the network node may configure a UE to perform beam reporting using component-carrier-specific reporting and/or BWP-specific reporting. That is, the UE may receive and use a respective reference signal (RS) resource configuration for each component carrier and/or BWP. Alternatively, or additionally, based at least in part on receiving a respective report configuration for each component carrier and/or for each BWP in a component carrier, the UE may transmit a respective report for each component carrier and/or for each BWP, regardless of the component carriers and/or BWPs using a common analog beam, resulting in inefficient signaling overhead. That is, the UE may return multiple reports that include redundant and/or repetitive information based at least in part on the UE generating, and transmitting, multiple measurement metrics for a common analog beam that is used by the multiple component carriers and/or BWPs, resulting in inefficient uplink signaling overhead. The inefficient signaling overhead may lead to increased data transfer latencies and/or reduced data throughput in a wireless network.

Various aspects relate generally to cross-component carrier joint beam reporting. Some aspects more specifically relate to a network node configuring a UE to generate a beam report that is associated with multiple component carriers using one or more beams that are common to the multiple component carriers. In some aspects, a network node may transmit an RS resource set configuration that indicates one or more RS resource linkages between RS resources in a first RS resource set that is associated with a first component carrier and RS resources in a second RS resource set that is associated with a second component carrier. For instance, each respective RS resource linkage may indicate an association between at least a first respective RS resource in the first RS resource set and a second respective RS resource in the second RS resource set. Alternatively, or additionally, each respective RS resource linkage may be associated with a respective common RS transmit beam of one or more common RS transmit beams. Based at least in part on transmitting the RS resource set configuration, the network node may transmit a report configuration that indicates an RS resource set linkage between the first RS resource set and the second RS resource set and an instruction to perform cross-component carrier joint beam reporting based at least in part on the RS resource set linkage and the one or more common RS transmit beams.

In some aspects, a UE may receive an RS resource set configuration that indicates one or more RS resource linkages between a first RS resource set that is associated with a first component carrier and a second RS resource set that is associated with a second component carrier. Each respective RS resource linkage of the one or more RS resource linkages may indicate an association between at least a first respective RS resource in the first RS resource set and a second respective RS resource in the second RS resource set. Alternatively, or additionally, each respective RS resource linkage may be associated with a respective common RS transmit beam of one or more common RS transmit beams. Based at least in part on receiving the RS resource set configuration, the UE may receive a report configuration that indicates an RS resource set linkage between the first RS resource set and the second RS resource set and an instruction to perform cross-component carrier joint beam reporting based at least in part on the RS resource set linkage and the one or more common RS transmit beams.

Particular aspects of the subject matter described in this disclosure can be implemented to realize one or more of the following potential advantages. In some examples, by transmitting an RS resource set configuration that indicates RS resource linkage(s) between RS resource sets associated with different component carriers in combination with transmitting a report configuration that indicates an RS resource set linkage between the RS resource set(s) and to perform cross-component carrier joint beam reporting, the described techniques can be used by a network node to reduce reporting signaling overhead by a UE in a manner that enables the network node to receive BWP-specific reports that provide information about dynamically changing channel conditions. The reduced signaling overhead may increase an efficiency of air interface resource usage, resulting in increased data throughput and/or reduced data transfer latencies, and BWP-specific information indicated in the reports may enable the network node to schedule transmissions in the BWP and/or modify an active BWP used by the UE to adapt to the dynamically changing channel conditions in a manner that increases data throughput, reduces data recovery errors, and/or reduces data transfer latencies.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

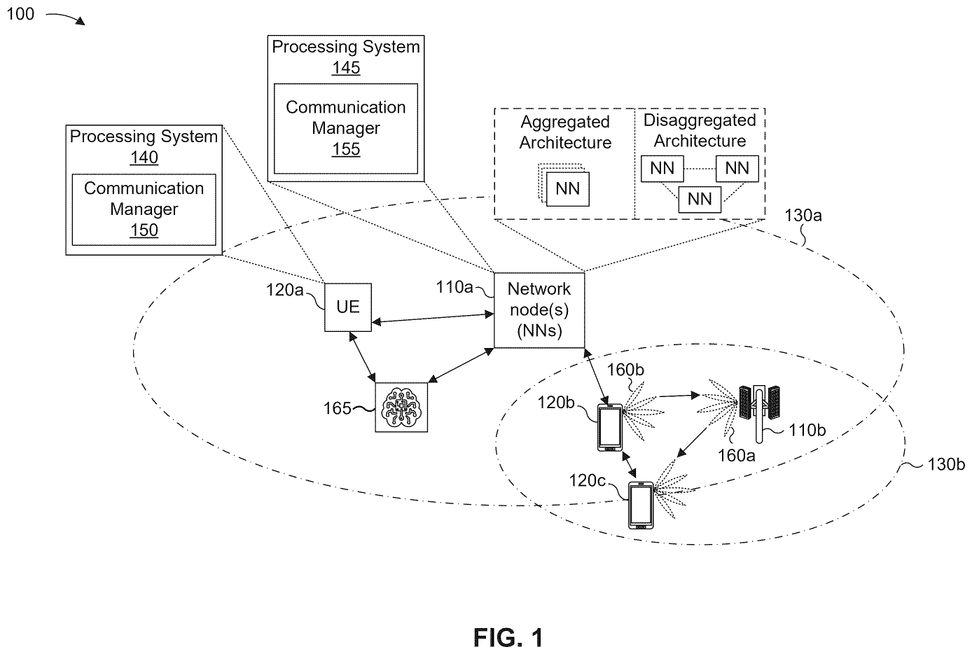

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

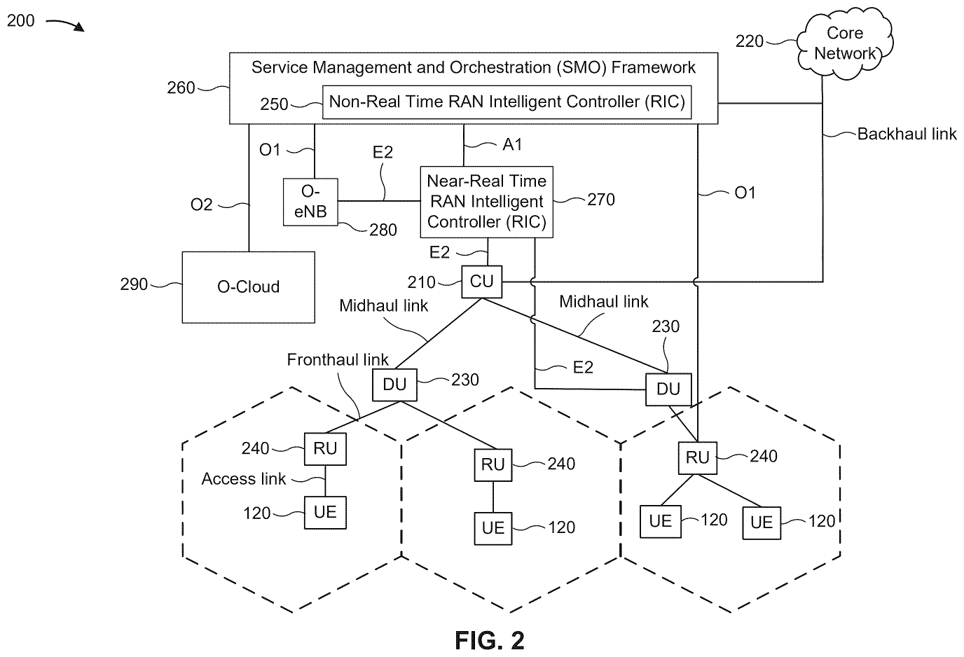

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-located (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a network node (e.g., a network node 110) may include a communication manager 155. As described in more detail elsewhere herein, the communication manager 155 may transmit an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and transmit a report configuration that indicates: an RS resource set linkage between the first RS resource set and the second RS resource set, and an instruction to perform cross-component carrier joint beam reporting based at least in part on the RS resource set linkage and the one or more common RS transmit beams. Additionally, or alternatively, the communication manager 155 may perform one or more other operations described herein.

In some aspects, a UE (e.g., a UE 120) may include a communication manager 150. As described in more detail elsewhere herein, the communication manager 150 may receive an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and receive a report configuration that indicates: an RS resource set linkage between the first RS resource set and the second RS resource set, and an instruction to perform cross-component carrier joint beam reporting based at least in part on the RS resource set linkage and the one or more common RS transmit beams. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

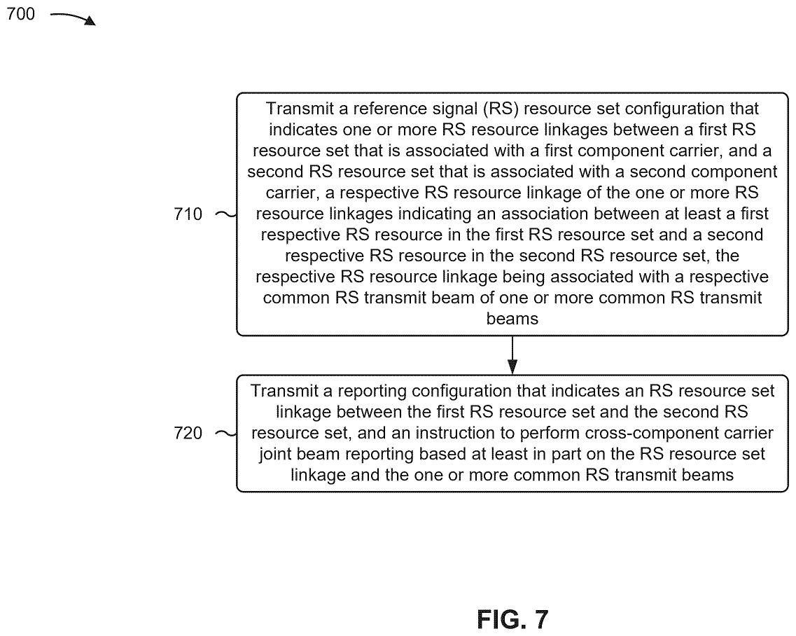

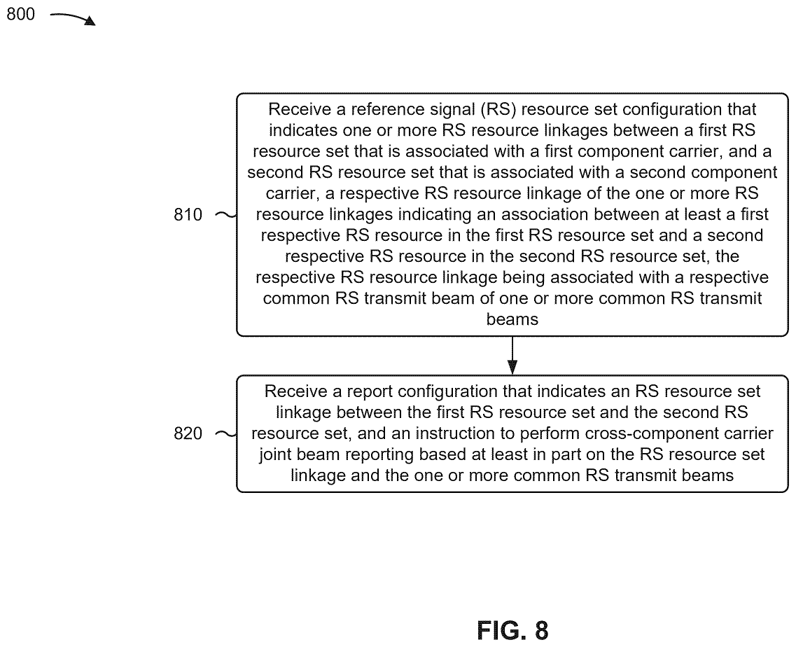

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with cross-component carrier joint beam reporting, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

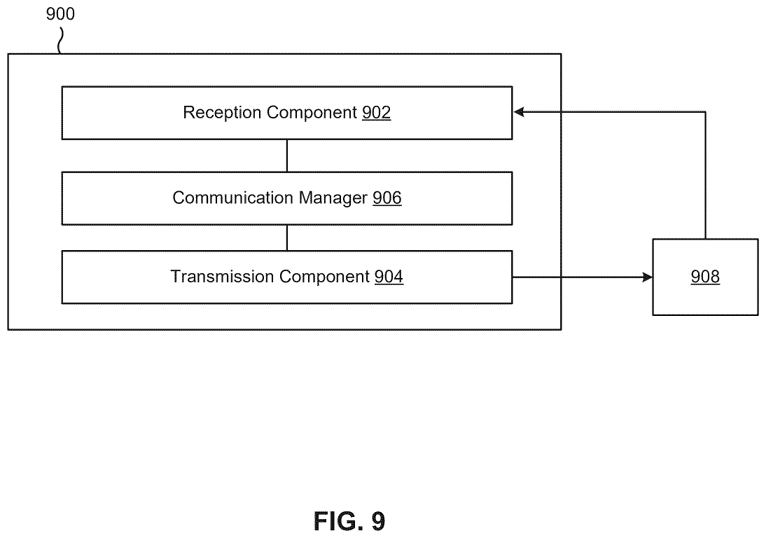

In some aspects, a network node (e.g., a network node 110) includes means for transmitting an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and/or means for transmitting a report configuration that indicates: an RS resource set linkage between the first RS resource set and the second RS resource set, and an instruction to perform cross-component carrier joint beam reporting based at least in part on the RS resource set linkage and the one or more common RS transmit beams. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

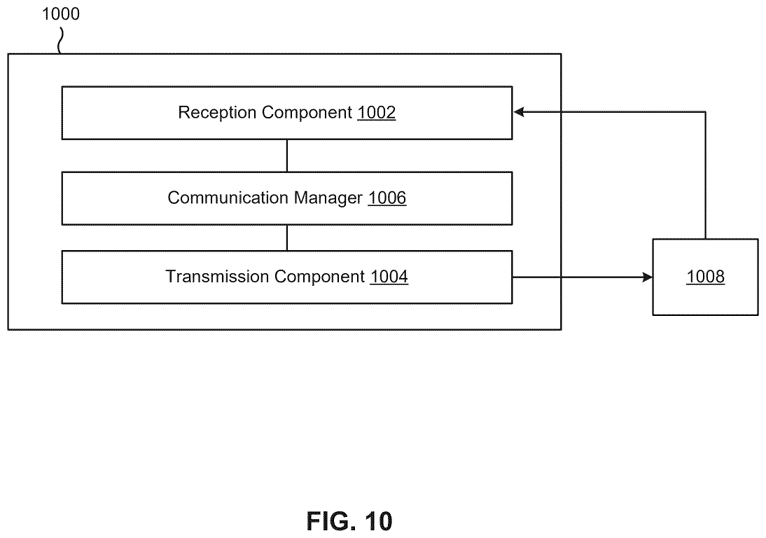

In some aspects, a UE (e.g., a UE 120) includes means for receiving an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and/or means for receiving a report configuration that indicates: an RS resource set linkage between the first RS resource set and the second RS resource set, and an instruction to perform cross-component carrier joint beam reporting based at least in part on the RS resource set linkage and the one or more common RS transmit beams. The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

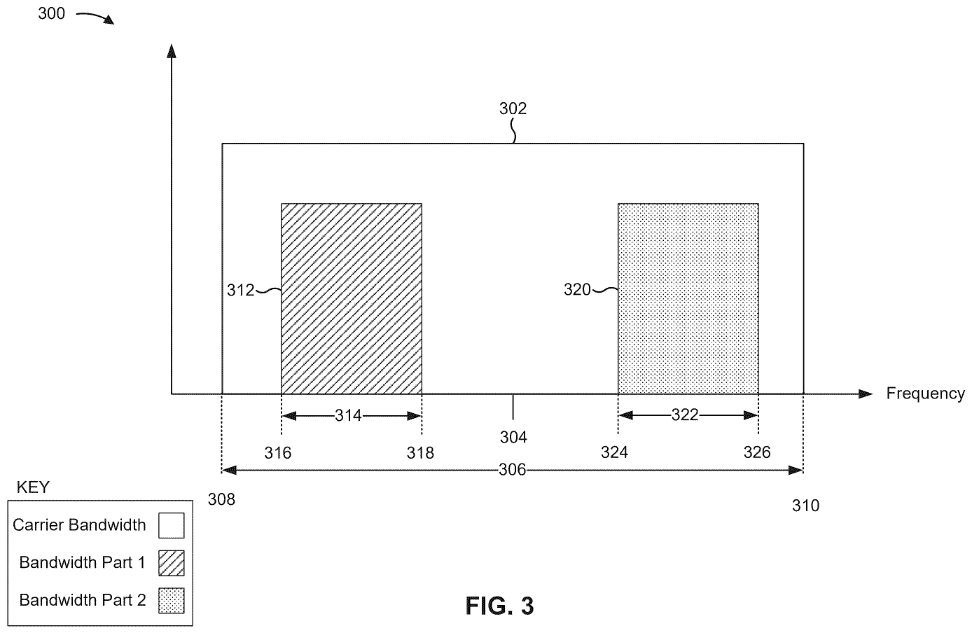

FIG. 3 is a diagram illustrating an example 300 of a BWP, in accordance with the present disclosure.

In some aspects, a wireless communication channel, alternatively referred to as a “carrier”, may be based at least in part on a center frequency, a frequency bandwidth, and or a set of RBs. To illustrate, a carrier 302 (shown in solid white) may be based at least in part on a center frequency 304 (e.g., a carrier frequency) and a frequency bandwidth 306. The frequency bandwidth 306 of the carrier 302 may be based at least in part on a first edge frequency 308 and a second edge frequency 310. Each RB of the carrier may include a group of REs that are characterized by a frequency partition and a time partition. Accordingly, the set of RBs associated with the carrier 302 may collectively span a bandwidth (e.g., the frequency bandwidth 306) and time duration. A component carrier is an individual carrier that may be integrated with other carriers through carrier aggregation.

A “bandwidth part” (or “BWP”) may denote a subset of contiguous RBs (and/or REs) within the set of RBs associated with a carrier, and a carrier may be partitioned into multiple BWPs (e.g., four). The ability to partition the carrier into BWPs may provide flexibility and efficient usage of the bandwidth associated with the carrier. To illustrate, the frequency bandwidth 306 may span 100 MHz and may be referred to as a wideband channel. Some UEs, such as an IoT device and/or a reduced capacity (RedCap) device, may lack capabilities that support wideband communications. For example, an IoT device may lack a transceiver with capabilities to transmit and/or receive a wideband signal. Alternatively, or additionally, the IoT device may lack a processor with capabilities to process digital samples associated with the wideband signal in real-time. Accordingly, a network node may partition a carrier into one or more BWPs for communicating with the IoT and/or other types of UEs. To illustrate, the network node may select and/or configure a first BWP 312 (shown by a diagonal line hash pattern) within the carrier 302 based at least in part on a frequency bandwidth 314, a first frequency edge 316, and a second frequency edge 318. The network node may select and/or configure a second BWP 320 (shown by a dotted pattern) within the carrier 302 based at least in part on a frequency bandwidth 322, a first frequency edge 324, and a second frequency edge 326. The network node may select a preconfigured BWP (e.g., defined by a communication standard) and/or may dynamically configure a BWP (e.g., dynamically select a bandwidth and/or a frequency edge) Although the example 300 shows the first BWP 312 and the second BWP 320 as having equal bandwidths and being positioned symmetrically within the carrier 302, other examples may include BWPs in a same carrier that have different characteristics (e.g., frequency bandwidths). To illustrate, the first BWP 312 may be configured with a larger bandwidth relative to the second BWP 320 based at least in part on the first BWP 312 being used for a higher data throughput relative to the second BWP 320. The second BWP 320 may be configured with a smaller bandwidth relative to the first BWP 312 based at least in part on reducing a transmission size and/or processing associated with the transmission to reduce power consumption at a UE. Thus, a network node may configure and/or select a BWP based at least in part on a variety of factors, such as UE power requirements, data throughput, and/or spectrum usage. For instance, the network node may configure and/or select a BWP associated with a frequency bandwidth of 5 MHz based at least in part on using the BWP for communications with a RedCap UE and/or an IoT with limited capabilities as further described above.

In some aspects, only a single BWP of the multiple BWPs may be active per transmission direction at a given time, such as a single active BWP for uplink (UL) transmissions and/or a single active BWP for DL transmissions. Alternatively, or additionally, the single active BWP may be associated with bi-directional transmissions, such as TDD transmissions that share a same frequency for UL and DL transmissions based at least in part on time partitioning. Accordingly, a network node (e.g., the network node 110) may direct a UE (e.g., the UE 120) to switch from using a first BWP as an active BWP to using a second BWP as the active BWP. To illustrate, the UE may utilize an initial BWP when operating in a radio resource control idle (RRC_IDLE) mode and switch to a different BWP when operating in a radio resource control connected (RRC_CONNECTED) mode. That is, the UE may communicate with the network node by initially using the initial BWP as the active BWP and then switch to using the different BWP as the active BWP.

As indicated above, FIG. 3 is provided as an example. Other examples may differ from what is described with regard to FIG. 3.

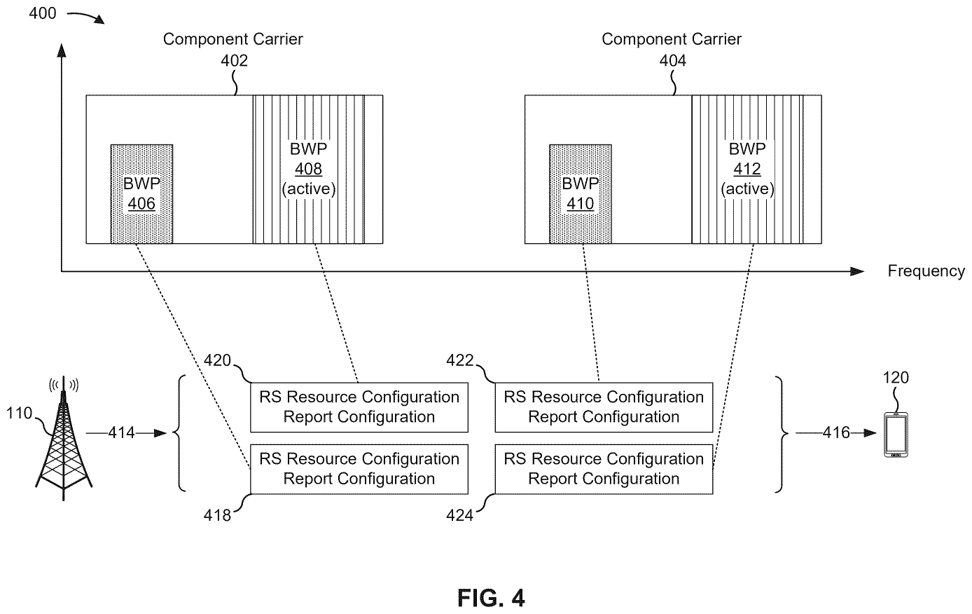

FIG. 4 is a diagram illustrating an example 400 of BWP channel feedback, in accordance with the present disclosure.

A network node 110 may configure a UE 120 with multiple component carriers for a variety purposes, such as to increase data throughput, to enable efficient spectrum usage, and/or to balance traffic loads across different frequency bands. In the example 400, the UE 120 is configured with at least a first component carrier 402 and a second component carrier 404. Each component carrier may include multiple BWPs, which are shown by FIG. 4 as BWP 406 and BWP 408 in the first component carrier 402, and BWP 410 and BWP 412 in the second component carrier 404. In a similar manner as described with regard to FIG. 3, a communication standard may specify that each component carrier of the UE 120 may have a single active BWP in a single slot. In FIG. 4, active BWPs are shown through the use of a vertical stripe (e.g., the BWP 408 in the first component carrier and the BWP 412 in the second component carrier 404) and inactive BWPs are shown through the use of a dotted pattern (e.g., the BWP 406 in the first component carrier and the BWP 410 in the second component carrier).

The network node 110 may configure the UE 120 to generate and report one or more measurement metrics for each BWP that enables the network node to schedule and/or manage resources in an efficient and/or optimized manner. For example, the network node 110 may configure the UE 120 to generate channel quality metrics, such as CSI, for downlink BWPs. The network node 110 may use the measurement metric(s) to select a beam configuration, an MCS, precoding, and/or an active BWP that increases data throughput, reduces data recovery errors, and/or reduces data transfer latencies in a wireless network. Because each BWP associated with the UE 120 may experience different channel conditions, the network node 110 may configure the UE 120 to report respective measurement metric(s) for each BWP, such as BWP-specific channel quality metrics and/or BWP-specific CSI. The BWP-specific measurement metrics may provide the network node 110 with more accurate information that enable the network node 110 to select optimized scheduling parameters for a BWP and/or to change the active BWP to a different BWP in a manner that increases data throughput, reduces data recovery errors, and/or reduces data transfer latencies. The network node 110 may request that the UE 120 return multiple BWP-specific reports to monitor dynamically changing channel conditions.

To illustrate BWP-specific measurement configuration and/or BWP-specific reporting, the network node 110 may transmit, and the UE 120 may receive, a respective RS resource set configuration and/or a respective report configuration for each BWP as shown by reference number 414 and reference number 416. For example, as shown by reference number 418, the network node 110 may transmit an RS resource configuration (e.g., using a first CSI-ResourceConfig information element (IE)) and a first report configuration (e.g., using a first CSI-ReportConfig IE), where the first RS resource set configuration and the first report configuration may be configured for, and/or associated with, the BWP 406 of the first component carrier 402. An RS resource set configuration may indicate one or more resource configuration parameters that may be used by the UE 120 to acquire a reference signal (e.g., a resource mapping parameter, a sub-carrier spacing parameter, a periodicity parameter, an offset parameter, a frequency domain allocation, and/or one or more RS resource sets that indicates a set of RS resources), and a report configuration may instruct the UE 120 how to generate and/or report measurement metrics. Examples of information that may be included in a report configuration may include any combination of a codebook configuration, a time-domain reporting behavior, frequency granularity for reporting metrics (e.g., CQI and/or a PMI), measurement restriction configurations, and/or CSI-related quantities (e.g., Layer 1 RSRP and/or Layer 1 SINR).

The network node 110 may transmit a respective RS resource set configuration and respective report configuration to the UE 120 for each BWP that is associated with the UE 120. For instance, the network node 110 may transmit a second RS resource set configuration and a second report configuration as shown by reference number 420, and the second RS resource set configuration and the second report configuration may be associated with the BWP 408 that is included in the first component carrier 402. Alternatively, or additionally, the network node 110 may transmit a third RS resource set configuration and a third report configuration as shown by reference number 422 and/or a fourth RS resource set configuration and a fourth report configuration as shown by reference number 424 that are associated with the BWP 410 and the BWP 412 of the second component carrier 404, respectively.

Configuring a UE to return multiple BWP-specific reports and/or multiple component carrier-specific report may lead to inefficient signaling overhead, decreased data throughput, and/or increased data transfer latencies in a wireless network. For instance, a network node operating in the FR2 band may include a select number of TXRUs (e.g., fewer than 4), and each TXRU may include, or be connected to, a substantial number of antenna elements (e.g., 64 or greater antenna elements). To achieve a high EIRP level, the network node may rely upon primarily on analog beamforming. To illustrate, in analog beamforming, the antenna elements may share a single RF chain antenna array, and beamforming may be achieved by applying a respective phase shift to each antenna element. Accordingly, each antenna element may amplify the same signal (e.g., with a respective phase shift), which may increase a power level of the output signal.

In some scenarios, a single TXRU may support multiple component carriers using a common analog beam. For example, in a first scenario, a network node (e.g., the network node 110) may contemporaneously support 8 component carriers using 4 TXRUs such that at least two component carriers are supported by the network node using a same TXRU and a common analog beam. Although a single TXRU may manage multiple component carriers based at least in part on using a common analog beam, the network node may configure a UE (e.g., the UE 120) to perform BWP-specific beam reporting and/or component carrier-specific reporting. That is, the network node may transmit a respective RS resource set configuration and a respective report configuration for each component carrier and/or each BWP in a component carrier of the UE, and RS resource set configurations and/or report configurations may include redundant and/or repetitive information (information that is associated with the common analog beam). Alternatively, or additionally, the UE may return multiple reports that include redundant and/or repetitive information based at least in part on the UE generating, and transmitting, multiple measurement metrics for a common analog beam that is used by the multiple component carriers and/or the BWPs. The redundant and/or repetitive information may lead to inefficient use of air interface resources (e.g., downlink and uplink), increased data transfer latencies, and/or reduced data throughput in a wireless network.

Various aspects relate generally to cross-component carrier joint beam reporting. Some aspects more specifically relate to a network node configuring a UE to generate a beam report that is associated with multiple component carriers using one or more beams that are common to the multiple component carriers. In some aspects, a network node may transmit an RS resource set configuration that indicates one or more RS resource linkages between RS resources in a first RS resource set that is associated with a first component carrier and RS resources in a second RS resource set that is associated with a second component carrier. For instance, each respective RS resource linkage may indicate an association between at least a first respective RS resource in the first RS resource set and a second respective RS resource in the second RS resource set. Alternatively, or additionally, each respective RS resource linkage may be associated with a respective common RS transmit beam of one or more common RS transmit beams. Based at least in part on transmitting the RS resource set configuration, the network node may transmit a report configuration that indicates an RS resource set linkage between the first RS resource set and the second RS resource set and an instruction to perform cross-component carrier joint beam reporting based at least in part on the RS resource set linkage and the one or more common RS transmit beams.

In some aspects, a UE may receive an RS resource set configuration that indicates one or more RS resource linkages between RS resources in a first RS resource set that is associated with a first component carrier and RS resources in a second RS resource set that is associated with a second component carrier. For instance, each respective RS resource linkage may indicate an association between at least a first respective RS resource in the first RS resource set and a second respective RS resource in the second RS resource set. Alternatively, or additionally, each respective RS resource linkage may be associated with a respective common RS transmit beam of one or more common RS transmit beams. Based at least in part on receiving the RS resource set configuration, the UE may receive a report configuration that indicates an RS resource set linkage between the first RS resource set and the second RS resource set and an instruction to perform cross-component carrier joint beam reporting based at least in part on the RS resource set linkage and the one or more common RS transmit beams.

Particular aspects of the subject matter described in this disclosure can be implemented to realize one or more of the following potential advantages. In some examples, by transmitting an RS resource set configuration indicates RS resource linkage(s) between RS resources in RS resource sets that are associated with different component carriers in combination with a transmitting a report configuration that indicates an RS resource set linkage between the RS resource set(s), the described techniques may enable a network node to reduce a signaling overhead and receive BWP-specific reports that provide information about dynamically changing channel conditions. For instance, the network node may reduce a signaling overhead associated with a UE reporting the BWP-specific reports. The reduced signaling overhead may increase an efficiency of air interface resource usage, resulting in increased data throughput and/or reduced data transfer latencies, and BWP-specific information indicated in the reports may enable the network node to schedule transmissions in a BWP and/or modify an active BWP in a manner that increases data throughput, reduces data recovery errors, and/or reduces data transfer latencies.

To illustrate, the network node may use beam reporting to select a single best common beam that may be used for multiple component carriers. Using per-component carrier reporting and/or per-BWP reporting (e.g., not common beam reporting), the network node may configure a UE to return 4 beam reports per component carrier, and each report may be associated with a different beam. Accordingly, and based at least in part on the per-component carrier reporting and/or the per BWP reporting, the UE may return, for each component carrier report, a report that indicates the 4 beams out of 32 beams that have the best measurement metric for each component carrier, such as the 4 beams associated with the highest RSRP metrics out of 32 RSRP metrics. To return reports in UCI, the UE may use 20 bits to indicate beam identifiers (IDs) of the 4 beams (e.g., five (5) bits per beam ID for 4 beams), and 20 bits to return the associated measurement metrics (e.g., 8+(3×4)), totaling 40 bits for each report. Using cross-component carrier reporting that is based at least in part on a common RS transmit beam, the UE may return, in the per component carrier report, one (1) best common beam from the total of 32 common beams for the component carrier. In the report, the UE may use 5 bits to indicate the beam ID and 8 bits to return the measurement metric, totaling 13 bits in each beam report.

As indicated above, FIG. 4 is provided as an example. Other examples may differ from what is described with regard to FIG. 4.

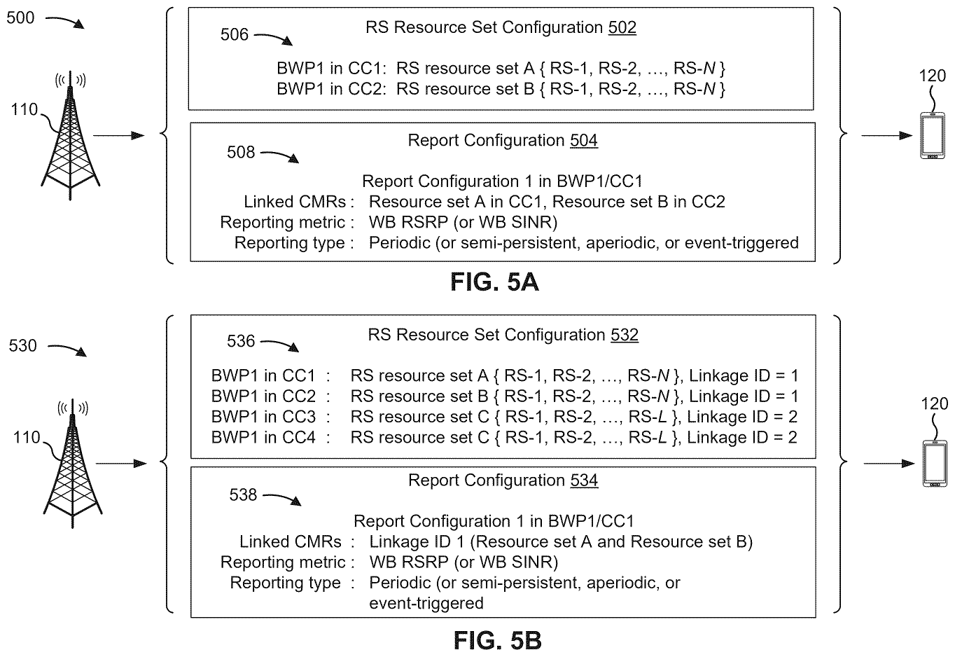

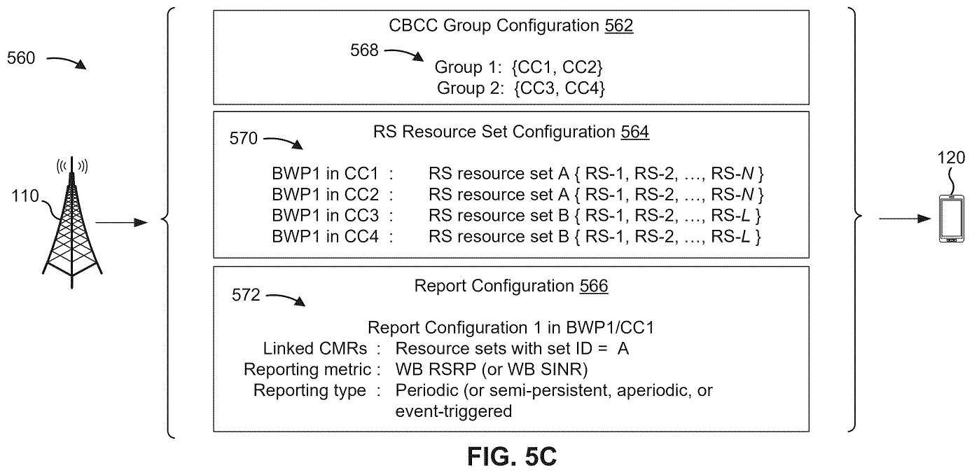

FIGS. 5A, 5B, and 5C are diagrams illustrating a first example 500, a second example 530, and a third example 560, respectively, of cross-component carrier joint beam reporting messaging, in accordance with the present disclosure.

A cross-component carrier joint beam reporting procedure, also referred to as a common beam reporting procedure, may be based at least in part on a network node 110 and/or a UE 120 using a common RS transmit beam for multiple component carriers and/or BWPs in different component carriers. “Cross-component carrier joint beam reporting” denotes beam reporting and/or beam measurement metrics that are based at least in part on common beam that applies to two or more component carriers and/or two or more RS resource sets that are associated with respective component carriers of the two or more component carriers. In some aspects, as at least part of the cross-component carrier joint beam reporting procedure, a network node (e.g., a network node 110) may indicate one or more linkages between RS resources in different RS resource sets that are associated with different component carriers to a UE (e.g., a UE 120). FIG. 5A illustrates a first example 500 that includes a network node 110 indicating an RS resource set configuration 502 and a report configuration 504 that, collectively, indicate one or more RS resource linkages and/or one or more RS resource set linkages that may be used for cross-component carrier joint beam reporting. As one example, the network node 110 may indicate an RS resource linkage between RS resources that are in different RS resource sets by indicating a same RS resource IDs for the linked RS resources. As indicated above, the different RS resources sets may be associated with different component carriers such that the RS resource set configuration 502 indicates a RS resource linkage that is a cross-component carrier RS resource linkage.

The network node 110 may transmit the RS resource set configuration 502 in Layer 3 signaling (e.g., RRC signaling), and the RS resource set configuration 502 may include one or more information elements (IEs) that include and/or indicate one or more parameters as shown by reference number 506. The parameters shown by reference number 506 may configure RS resource sets for different component carriers, and the RS resource set configuration 502 may indicate that the RS resource sets include one or more RS resource linkages (e.g., cross-component carrier RS resource linkages). For instance, the RS resource set configuration 502 indicates a first configuration of a first RS resource set that is associated with a first BWP that is included a first component carrier (shown by FIG. 5A as RS resource set A and BWP1 in CC1, respectively), and a second configuration of a second RS resource set that is associated with a second BWP that is included in a second component carrier (shown by FIG. 5A as RS resource set B and BWP1 in CC2, respectively). Each respective RS resource linkage between the first RS resource set and the second RS resource set may be indicated by the RS resource set configuration 502 through the use of a same respective RS resource ID.

In some aspects, an RS resource linkage indicated in an RS resource set configuration may be based on an RS resource set configuration indicating and/or configuring each BWP of each component carrier associated with a RS resource linkage with at least one RS resource set that include a same quantity and/or a common number of RS resources. For instance, the RS resource set configuration 502 configures the first RS resource set and the second RS resource set (e.g., RS resource set A and RS resource set B, respectively) with a same quantity of RS resources, shown by FIG. 5A as N RS resources. Based at least in part on the first RS resource set and the second RS resource set including a same quantity of RS resources, the RS resource set configuration may indicate linked RS resources through the use of a same RS resource ID as described above. That is, a same RS resource ID indicates linked RS resources in RS resource sets that include a same quantity of RS resources and/or are associated with different component carriers. To illustrate, with regard to FIG. 5A, RS-1 in RS resource set A may be set to a same RS resource ID as RS-1 in RS resource set B. Linked RS resources that are associated with different component carriers may be any suitable type of RS, such as an SSB and/or a CSI-RS.

In some aspects, linked RS resources (e.g., indicated through the use of a same RS resource ID) may use and/or be associated with a common RS transmit beam and/or a same RS transmit beam. Accordingly, the indication of a linked RS resource may instruct the UE 120 to use the common RS transmit beam and/or a same RS transmit beam for each RS resource in generating a cross-component carrier joint report. procedure. Each respective RS linkage between RS resources in RS resource sets may be associated with a respective RS transmit beam. For instance, a first common RS transmit beam may be associated with a first RS linkage between a first set of RS resources (e.g., two or more RS resources), a second common RS transmit beam may be associated with a second RS linkage between a second set of RS resources, and/or a third common RS transmit beam may be associated with a third RS linkage between a third set of RS resources. With regard to FIG. 5A, the N RS resources in the RS resource set A and the RS resource set B may include N RS resource linkages, and each RS resource linkage may be associated with a respective common RS transmit beam, totaling N common RS transmit beams for the entirety of the N RS resources.

In the first example 500, a first RS resource set and a second RS resource set are configured with one or more RS resource linkages (e.g., indicated through the use of a respective same RS resource ID for each RS resource linkage). Although an RS resource linkage described with regard to the first example 500 is based at least in part on two RS resource sets and, consequently, two RS resources, other examples of RS resource linkages may be based at least in part on more than two RS resources and/or more than two RS resource sets. To illustrate, three RS resource sets associated with three different component carriers may include one or more RS resource linkages that are associated with a respective RS resource in each respective RS resource set.

The RS resources that are associated with one another through an RS resource linkage may form a virtual resource. For instance, with regard to FIG. 5A, RS-1 of RS resource set A and RS-1 of RS resource set B may collectively form a first virtual resource, and RS-N of RS resource set A and RS-N of RS resource B may form an N-th virtual resource. In some aspects, a virtual resource may be assigned a same RS resource ID as the RS resources included in the virtual resource. For example, the first virtual resource that includes RS-1 of RS resource set A and RS-1 of RS resource set B may be assigned, implicitly or explicitly, a same RS resource ID that is associated with RS-1 of RS resource set A and RS-1 of RS resource set B. Accordingly, a virtual resource may be formed and/or associated with at least two linked RS resources in respective RS resource sets. In some aspects, the respective RS resource sets may be linked RS resource sets as described below with regard to the report configuration 504, and each respective RS resource set may be associated with a respective component carrier. A virtual resource may be referred to using the same RS resource ID that is assigned to the linked RS resources included in the virtual resource.

As shown by FIG. 5A, the network node 110 may transmit the report configuration 504, and the report configuration 504 may indicate, and/or configure one or more parameters that are used by the UE 120 for cross-component carrier joint beam reporting. In a similar manner as the RS resource set configuration 502, the network node may transmit the report configuration 504 in Layer 3 signaling (e.g., RRC signaling), and the report configuration 504 may indicate one or more parameters as shown by reference number 508. As one example, the report configuration 504 may include one or more IEs that indicate the parameters shown by reference number 508. The report configuration 504 may include multiple sets of parameters, and each set of parameters may be labeled and/or assigned a respective common beam report configuration ID. For instance, the parameters shown by reference number 508 may be configured with values that are optmized for and/or associated with the first component carrier and/or the first BWP in the first component carrier (e.g., BWP1/CC1), and the report configuration 504 may configure and/or assign the parameters shown by reference number 508 with a first common beam report configuration ID (shown by FIG. 5A as Report configuration 1). The report configuration 504 may include additional sets of parameters that are labeled and/or assigned a respective common beam report configuration ID and/or are configured with values that are optimized for and/or associated with a respective component carrier and/or a respective BWP.

As shown by reference number 508, the report configuration 504 may include and/or indicate two or more linked RS resource sets, also referred to as a RS resource set linkage. To illustrate, the report configuration 504 may indicate to perform cross-component carrier joint beam reporting using particular linked channel measurement references (CMRs). In the example 500, the report configuration 504 explicitly indicates, as the linked CMRs, a RS resource set linkage that includes the RS resource set A and the RS resource set B, but other examples may include a report configuration indicating more than two linked RS resource sets. In indicating the linked CMRs and/or the RS resource set linkage, the report configuration 504 may implicitly indicate to perform the cross-component carrier joint beam reporting using linked RS resources within the linked RS resource sets. That is, the report configuration 504 may implicitly indicate to perform the cross-component carrier joint beam reporting using each respective virtual resource within the linked RS resource sets that are indicated as a linked CMR and/or to perform the cross-component carrier joint beam reporting using a respective common RS transmit beam that is associated with the virtual resource. Alternatively, or additionally, the report configuration 504 may explicitly indicate one or more virtual resources within the linked RS resource sets to use for cross-component carrier joint beam reporting, such as by explicitly indicating an RS resource ID assigned to the virtual resource.

As shown by reference number 508, the report configuration 504 may indicate a reporting metric type to generate for cross-component carrier joint beam reporting using each virtual resource that is associated with the RS resource sets included in the indicated RS resource set linkage. For instance, the report configuration 504 may indicate to generate a wideband RSRP measurement metric and/or a wideband signal-to-interference-plus-noise ratio (SINR) measurement metric using the virtual resource(s). A bandwidth for a wideband measurement metric may be based at least in part on a number of component carriers associated with a virtual resource such that the bandwidth is large enough to include all of the component carriers.

Alternatively, or additionally, as shown be reference number 508, the report configuration 504 may indicate a reporting mode for the cross-component carrier joint beam reporting. As one example, the report configuration 504 may indicate to use a periodic reporting mode as the cross-component carrier joint beam reporting and/or an aperiodic reporting mode as the cross-component carrier joint beam reporting. In some aspects, the report configuration 504 may indicate to use a semi-persistent reporting mode and/or an event-triggered reporting mode as the cross-component carrier joint beam reporting. The report configuration 504 may indicate values that configure a reporting mode, such as a first value that specifies a duration for the semi-persistent reporting mode and/or a second value that specifies a periodicity for the periodic reporting mode. As another example, the report configuration 504 may specify an event and/or a value (e.g., a threshold value) that is used by the UE 120 to identify an occurrence of a reporting event. To illustrate, the report configuration 504 may indicate to use an event trigger that is based at least in part on a first wideband measurement metric (e.g., of a candidate beam that is being evaluated) differing from a second wideband measurement metric (e.g., of a current beam being used) by a difference threshold. The report configuration 504 may indicate the type of wideband measurement metric and/or a value of the difference threshold to use to identify the occurrence of a reporting event.

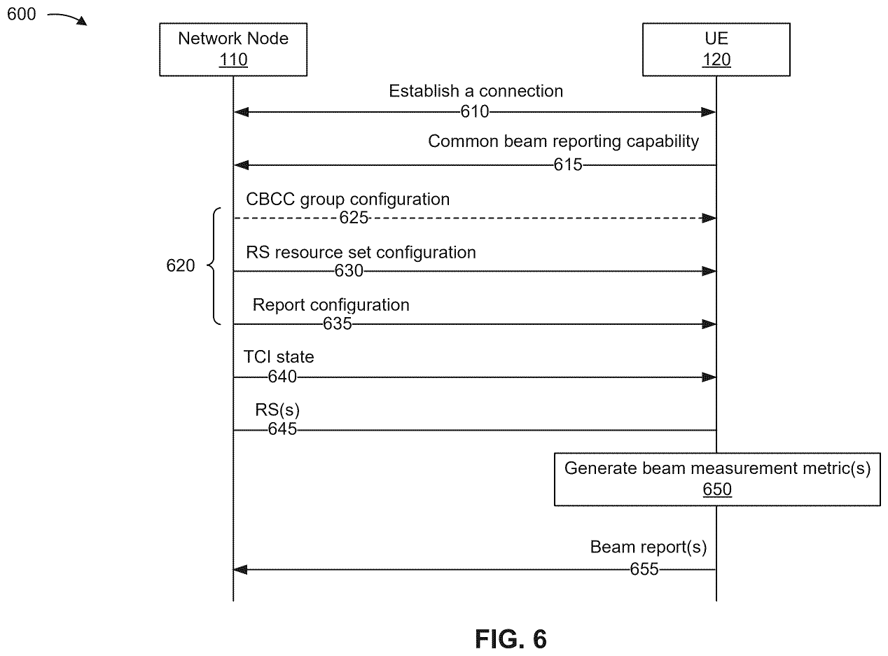

As described below with regard to FIG. 6, the UE 120 may use a combination of the RS resource set configuration 502 and the report configuration 504 to identify one or more RS resource linkages (e.g., that are between different component carriers) based at least in part on an RS resource ID and/or one or more RS resource set linkages (e.g., explicitly indicated). The UE 120 may generate and/or transmit a cross-component carrier beam report based at least in part on the RS resource linkages, RS resource set linkages, and/or a report configuration.

The second example 530 shown by FIG. 5B includes the network node 110 indicating an RS resource set configuration 532 and a report configuration 534. In a similar manner as described with regard to FIG. 5A, the network node 110 may transmit the RS resource set configuration 532 and/or the report configuration 534 in Layer 3 signaling and/or using IEs. Collectively, the RS resource set configuration 532 and the report configuration 534 may indicate one or more RS resource linkages and/or one or more RS resource set linkages that may be used by the UE 120 for cross-component carrier joint beam reporting.

As shown by FIG. 5B, the RS resource set configuration 532 indicates configurations for multiple RS resource sets, and each RS resource set is associated with a respective component carriers. To illustrate, and as shown by reference number 536, the RS resource set configuration 532 indicates a first RS resource set that is associated with a first BWP that is included in a first component carrier (shown by FIG. 5B as RS resource set A for BWP1 in CC1) and a second RS resource set that is associated with a first BWP that is included in a second component carrier (shown by FIG. 5B as RS resource set B for BWP1 in CC2). In a similar manner as described with regard to FIG. 5A, the RS resource set A and the RS resource set B include a same quantity of RS resources that are labeled as RS-1, RS-2, up to RS-N. In the second example 530, the RS resource set configuration 532 indicates a RS resource set linkage between the first RS resource set and the second RS resource set by indicating a same linkage ID for each RS resource set, which is shown by FIG. 5B as Linkage ID=1.

The RS resource set configuration 532 also indicates a third RS resource set that is associated with a first BWP that is included in a third component carrier (shown by FIG. 5B as RS resource set C for BWP1 in CC3) and a fourth RS resource set that is associated with a first BWP that is included in a fourth component carrier (shown by FIG. 5B as RS resource set D for BWP1 in CC4). The RS resource set configuration 532 configures the third RS resource set and the fourth RS resource set include a same quantity of RS resources (e.g., RS-1, RS-2, up to RS-L). The RS resource set configuration 532 indicates a RS resource set linkage between the third RS resource set and the fourth RS resource set by indicating a same linkage ID for each RS resource set, shown by FIG. 5B as Linkage ID=2.

In a similar manner as described with regard to FIG. 5A, the RS resource set configuration 532 may indicate RS resource linkage(s) between RS resources in linked RS resource sets based at least in part on indicating a same RS resource ID for linked RS resources. The linked RS resources included in linked RS resource sets may be any suitable type of RS, such as an SSB and/or a CSI-RS. Alternatively, or additionally, the linked RS resources may be associated with a same RS transmit beam and/or a common RS transmit beam as described above with regard to FIG. 5A. Linked RS resources that are included in linked RS resource sets may form a virtual resource as described above. A virtual resource may be configured with (and/or referenced using) the same RS resource ID that is common to the linked RS resources included in the virtual resource.

The network node 110 may transmit the report configuration 534 in Layer 3 signaling (e.g., RRC signaling), and the report configuration 534 may include one or more parameters as shown by reference number 538, such as by including one or more IEs. In a similar manner as the report configuration 504, the report configuration 534 may include multiple sets of parameters, and each set of parameters may be labeled and/or assigned a respective common beam report configuration ID. In FIG. 5B, the parameters shown by reference number 538 are assigned a common beam report configuration ID that is shown as Report configuration 1, and the parameters in the Report configuration 1 are associated with the first component carrier and/or the first BWP in the first component carrier (e.g., BWP1/CC1). The report configuration 534 may include additional sets of parameters that are labeled and/or assigned a respective common beam report configuration ID and/or are configured with values that are optimized for and/or associated with a respective component carrier and/or a respective BWP.

In the example 530, the report configuration 534 explicitly indicates one or more linked CMRs to use for cross-component carrier joint beam reporting by indicating an RS resource set linkage (shown as Linkage ID 1). To illustrate, the report configuration may include a linked CMR field that instructs the UE 120 to perform and/or transmit cross-component carrier joint beam reporting using the linked RS resource sets indicated in the linked CMR field. For instance, by indicating the linkage ID 1, the report configuration 534 indicates to perform cross-component carrier joint beam reporting using a linked RS resource set that includes the RS resource set A and RS resource set B. In indicating the linked CMRs, the report configuration 534 may implicitly indicate to perform the cross-component carrier joint beam reporting using linked RS resources and/or virtual resources included in the indicated linked RS resource set(s). In other examples, the report configuration 534 may explicitly indicate one or more virtual resources to use for cross-component carrier joint beam reporting by explicitly indicating one or more RS resource IDs that are assigned to the virtual resources.

The report configuration 534 may indicate a reporting metric type to use for cross-component carrier joint beam reporting, such as by indicating a wideband RSRP measurement metric and/or a wideband SINR measurement metric. Alternatively, or additionally, and as shown be reference number 538, the report configuration 534 may indicate a reporting mode for the cross-component carrier joint beam reporting, such as a periodic reporting mode, an aperiodic reporting mode, a semi-persistent reporting mode, and/or an event-triggered reporting mode as the described with regard to FIG. 5A. The report configuration 534 may indicate values that configure the reporting mode, such as a first value that specifies a duration, a second value that specifies a periodicity, an event type, and/or a threshold value as described above.

FIG. 5C illustrates a third example 560 that includes the network node 110 transmitting a common beam component carrier (CBCC) group configuration 562, an RS resource set configuration 564, and a report configuration 566 that, collectively, may indicate one or more RS resource linkages and/or one or more RS resource set linkages that may be used by the UE 120 for cross-component carrier joint beam reporting. “CBCC group” denotes a group of component carriers that use one or more common RS transmit beams and/or one or more same RS transmit beams (e.g., at a same time). To illustrate, as shown by reference number 568, the CBCC group configuration 562 indicates that a first CBCC group (shown by FIG. 5C as Group 1) includes a first component carrier and a second component carrier (shown by FIG. 5C as CC1 and CC2). The CBCC group configuration 562 also indicates that a second CBCC group includes a third component carrier and a fourth component carrier, shown by FIG. 5C as Group 3 that includes CC3 and CC4. In some aspects, the network node 110 may transmit an indication of the CBCC group configuration 562 in Layer 3 signaling. The CBCC group configuration 562 may, or may not, indicate a CBCC group ID for each group. As one example, the CBCC groups may be listed in a particular order within the CBCC group configuration 562, and a position in the list may implicitly indicate a group ID. As another example, the CBCC group configuration 562 may include a respective field for each CBCC group that is used to indicate a respective CBCC group ID. Each component carrier included in a group may be indicated by the CBCC group configuration 562 using a respective component carrier index. In some aspects, a communication standard may specify the respective component carrier indices, and in other aspects, the network node 110 may configure the respective component carrier indices, such as at least part of establishing a connection with the UE 120.

The RS resource set configuration 564 may indicate and/or configure multiple RS resource sets, and each RS resource set may be associated with a respective component carrier. For example, as shown by reference number 570, the RS resource set configuration 564 may include parameter(s) that configure RS resource sets, such as by indicating the set of RS resources included in each respective RS resource set and/or assigning a particular RS resource set to a particular component carrier and/or a particular BWP in the particular component carrier. In some aspects, the RS resource set configuration 564 may configure different component carriers with a same RS resource set and, consequently, indicate an RS resource set linkage between the different component carriers.

To illustrate, as shown by reference number 570, the RS resource set configuration 564 configures a first BWP that is included in a first component carrier (shown by 5C as BWP1 in CC1) with a first RS resource set (shown by FIG. 5C as RS resource set A). The RS resource set configuration 564 also configures a first BWP that is included in a second component carrier (shown by FIG. 5C as BWP1 in CC2) with the same first RS resource set (e.g., RS resource set A). Accordingly, the RS resource set configuration 564 may indicate that the first component carrier and the second component carrier have an RS resource set linkage based at least in part on the first component carrier and the second component carrier being in a same CBCC group and by configuring each component carrier with a same RS resource set. The RS resource set configuration 564 may assigned and/or configure the first RS resource set with an RS resource set ID (e.g., RS resource set A).

In a similar manner, the RS resource set configuration 564 indicates a second RS resource set (shown by FIG. 5C as RS resource set B) that is associated with a first BWP that is included in a third component carrier (shown by FIG. 5C as RS resource set B for BWP1 in CC3) and a first BWP that is included in a fourth component carrier (shown by FIG. 5C as BWP1 in CC4). That is, the RS resource set configuration 564 indicates an RS resource set linkage between the third component carrier and the fourth component carrier based at least in part on the third component carrier and the fourth component carrier being in a same CBCC group and by configuring each component carrier with a same RS resource set. The RS resource set configuration 564 may assigned and/or configure the second RS resource set with an RS resource set ID (e.g., RS resource set B).

In some aspects, an RS resource set linkage between component carriers may be based at least in part on each component carrier being included within a same CBCC group and/or based at least in part on the RS resource sets including a same quantity of RS resources. That is, each component carrier in a same CBCC group may share one or common RS transmit beams, and, consequently, may each be configured with at least one RS resource set that include a same quantity of RS resources. For example, the first component carrier and the second component carrier that are included together in the first CBCC group are each configured with the RS resource set A, resulting in each component carrier being configured a same quantity of RS resources (e.g., RS-1, RS-2, up to RS-N). Similarly, the third component carrier and the fourth component carrier that are included together in the second CBCC group are each configured with the RS resource set B, resulting in each component carrier being configured a same quantity of RS resources (e.g., RS-1, RS-2, up to RS-L).

In a similar manner as described with regard to FIG. 5A and FIG. 5B, the RS resource set configuration 564 may indicate an RS resource linkage between RS resources in RS resource sets (e.g., that are associated with respective component carriers) based at least in part on indicating a same RS resource ID for linked RS resources, and the linked RS resources may be associated with a same RS transmit beam and/or a common RS transmit beam. Alternatively, or additionally, and in a similar manner as described with regard to FIG. 5A and FIG. 5B, RS resources that are included in linked RS resource sets and are associated with one another through an RS resource linkage may form a virtual resource, and the virtual resource may be configured with (and/or referenced using) an RS resource ID that is common to the RS resources included in the virtual resource. The RS resources may be of any suitable RS type, such as an SSB and/or a CSI-RS.

As shown by FIG. 5C, the network node 110 may transmit the report configuration 566, and the report configuration 566 may indicate, and/or configure one or more parameters that are used by the UE 120 for cross-component carrier joint beam reporting. The network node may transmit the report configuration 504 in Layer 3 signaling (e.g., RRC signaling), and the report configuration 566 may indicate one or more parameters as shown by reference number 572. As one example, the report configuration 566 may include one or more IEs that indicate the parameters shown by reference number 572. In a similar manner as described with regard to FIG. 5A and FIG. 5B, the report configuration 566 may include multiple sets of parameters, and each set of parameters may be labeled and/or assigned a respective common beam report configuration ID. For instance, the parameters shown by reference number 572 may be configured with values that are optmized for and/or associated with the first component carrier and/or the first BWP in the first component carrier (e.g., BWP1/CC1), and the report configuration 555 may configure and/or assign the parameters shown by reference number 572 with a first common beam report configuration ID (shown by FIG. 5C as Report configuration 1). The report configuration 566 may include additional sets of parameters that are labeled and/or assigned a respective common beam report configuration ID and/or are configured with values that are optimized for and/or associated with a respective component carrier and/or a respective BWP.

In the third example 560, the report configuration 566 indicates to perform and/or transmit cross-component carrier joint beam reporting using one or more linked CMRs. For instance, the report configuration 566 may explicitly indicate an RS resource set ID in a linked CMR field, and the indication of the RS resource set ID in a CMR field may implicitly and/or explicitly instruct the UE 120 to perform cross-component carrier joint beam reporting using linked RS resources in RS resource sets that have the indicated RS resource set ID and are included in a same CBCC group. To illustrate, in the third example 560, the report configuration 566 indicates the RS resource set ID of “A” that instructs the UE 120 to perform cross-component carrier joint beam reporting using linked RS resources and/or virtual resources within the linked RS resource sets with an assigned RS resource set ID of “A” that are included in a same CBCC group. Alternatively, or additionally, the report configuration 566 may explicitly indicate one or more virtual resources to use for cross-component carrier joint beam reporting by indicating one or more RS resource IDs that are assigned to the virtual resources.

The report configuration 566 may indicate a reporting metric type to generate using an indicated virtual resource (e.g., via the linked CMR indication), such as by indicating a wideband RSRP measurement metric and/or a wideband SINR measurement metric. Alternatively, or additionally, the report configuration 566 may indicate a reporting mode for the cross-component carrier joint beam reporting, such as by indicating to use a periodic reporting mode, an aperiodic reporting mode, a semi-persistent reporting mode, and/or an event-triggered reporting mode as the described with regard to FIG. 5A and FIG. 5B The report configuration 566 may indicate values that configure the reporting mode, such as a first value that specifies a duration, a second value that specifies a periodicity, an event, and/or a threshold value.

A network node may reduce a signaling overhead that is associated with beam reporting by a UE by configuring the UE to perform cross-component carrier joint beam reporting. To illustrate, the network node may indicate one or more RS resource linkage(s) that link RS resources, and/or one or more RS resource set linkages that link RS resource sets, that are associated with different component carriers. The network node may indicate the RS resource linkage(s) and/or the RS resource set linkage(s) by indicating combination of a CBCC group configuration, an RS resource set configuration, and/or a report configuration as described herein. The linked RS resources that are within linked RS resource sets may use respective common RS transmit beams, resulting in a reduced number of beam reports transmitted by the UE and, consequently, reduced signaling overhead. The reduced signaling overhead may increase an efficiency of air interface resource usage, increased data throughput, and/or reduced data transfer latencies.

As indicated above, FIGS. 5A, 5B, and 5C are provided as examples. Other examples may differ from what is described with regard to FIGS. 5A, 5B, and 5C.

FIG. 6 is a diagram illustrating an example 600 of a wireless communication process between a network node (e.g., a network node 110) and a UE (e.g., a UE 120), in accordance with the present disclosure.

As shown by reference number 610, a network node 110 and a UE 120 may establish a connection. To illustrate, the UE 120 may power up in a cell coverage area provided by the network node 110, and the UE 120 and the network node 110 may perform one or more procedures (e.g., an RACH procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI and/or UCI), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

As shown by reference number 615, the UE 120 may transmit, and the network node 110 may receive, an indication of a common beam reporting capability. For instance, the UE 120 may indicate support for common beam reporting and/or cross-component carrier joint beam reporting. In some aspects, the UE 120 may indicate a granularity of support for common beam reporting, such as by indicating support for RS resource linkages, RS resource set linkages, and/or CBCC groups. For clarity, FIG. 6 illustrates the UE 120 transmitting the indication of the common beam reporting capability in a separate transaction than establishing a connection with the network node 110. However, in some aspects, the UE 120 may transmit the indication of the common beam reporting capability as part of establishing a connection with the network node 110.

As shown by reference number 620, the network node 110 may transmit, and the UE 120 may receive, an indication of one or more RS resource linkages and/or one or more RS resource set linkages. The network node 110 may indicate the RS resource linkage(s) and/or the RS resource set linkage(s) by indicating any combination of a CBCC group configuration, an RS resource set configuration, and/or a report configuration as described with regards to FIG. 5A, FIG. 5B, and FIG. 5C.

For example, as shown by reference number 625, the network node 110 may transmit, and the UE 120 may receive, an indication of a CBCC group configuration as described with regard to FIG. 5C. For instance, the CBCC group configuration may indicate groups of component carriers that use one or more common RS transmit beams. However, in some examples, the network node 110 may not transmit an indication of a CBCC group configuration, which is indicated by FIG. 6 through the use of a dashed line. For instance, the network node 110 may transmit the indication of the RS resource linkage(s) and/or the RS resource set linkage(s) as described with regard to FIG. 5A and FIG. 5B that do not send a CBCC group configuration.

As shown by reference number 630, the network node 110 may transmit, and the UE 120 may receive, an indication of an RS resource set configuration. As one example, the network node 110 may transmit an indication of an RS resource set configuration that indicates one or more RS resource linkages using a same RS resource ID for linked RS resources as described with regard to FIG. 5A, FIG. 5B, and FIG. 5C. Alternatively, or additionally, the network node 110 may transmit an indication of an RS resource set configuration that indicates an RS resource set linkage, such as by indicating a same linkage ID for linked RS resource sets as described with regard to FIG. 5B. In some aspects, the network node 110 may transmit an indication of an RS resource set configuration that indicates a same RS resource set is associated with different component carriers and/or BWPs that are in different component carriers in a same CBCC group as described with regard to FIG. 5C.

As shown by reference number 635, the network node 110 may transmit, and the UE 120 may receive, an indication of a report configuration. In some aspects, the report configuration may specify and/or indicate one or more linked CMRs to use for beam reporting as described with regard to FIG. 5A, FIG. 5B, and FIG. 5C. In some aspects, the report configuration may explicitly indicate which RS resource sets are linked RS resource sets as described with regard to FIG. 5A. In other aspects, the report configuration may indicate, as a linked CMR, a linkage ID as described with regard to FIG. 5B. Alternatively, or additionally, the report configuration may indicate an RS resource set ID as described with regard to FIG. 5C that indicates to perform joint cross-component carrier beam reporting using RS resource sets that are in a same CBCC group and have the indicated RS resource set ID.

The report configuration may indicate alternate or additional information as described with regard to FIG. 5A, FIG. 5B, and FIG. 5C. For instance, the report configuration may indicate a reporting mode to use for the cross-component carrier joint beam reporting, such as a periodic reporting mode, an aperiodic reporting mode, a semi-persistent reporting mode, and/or an event-triggered reporting mode. As another example, the report configuration may indicate a reporting metric type to generate and/or to include in a beam report, such as a wideband RSRP metric and/or a wideband SINR metric.

As shown by reference number 640, the network node 110 may transmit, and the UE 120 may receive, an indication of one or more TCI states, and the TCI state(s) may indicate one or more common RS transmit beams that are associated with cross-component carrier joint beam reporting. For example, as described above, an RS resource linkage between RS resources associated with different component carriers (and/or BWPs in different component carriers) may be based at least in part on a common RS transmit beam as described above. In some aspects, the network node 110 may indicate, via TCI state information, a QCL RS that may be a wideband RS that has a bandwidth that spans multiple component carriers. For example, the network node 110 may transmit an indication of a TCI state in DCI, and the TCI state may indicate a common TCI ID that is applicable to multiple component carriers. That is, the TCI ID may map to and/or reference a particular set of beamforming parameters and/or spatial parameters that are associated with a wideband QCL RS that applies to multiple component carriers.

As one example, to indicate that the TCI state is associated with a wideband QCL RS and/or a common TCI ID, the network node 110 may indicate one or more virtual resource IDs in the TCI state and/or a common beam report configuration ID, such as the common beam report configuration IDs described with regard to FIG. 5A, FIG. 5B, and FIG. 5C. As described above, a virtual resource ID may be a same value as an RS resource ID of each RS resource included in the virtual resource ID. A TCI pool may be configured with multiple TCIs that indicate virtual resource IDs and/or common beam report configuration IDs, and each TCI may be common and/or applicable to the multiple BWPs and/or the multiple component carriers that are associated with the virtual resource ID, linked RS resources, and/or linked RS resource sets.

As another example, the network node 110 may transmit an indication of a TCI state that is associated with a particular component carrier, and each indicated QCL RS associated with the TCI state may be associated with a resource ID (e.g., an actual resource ID) that refers to a physical time-frequency resource that is located in each component carrier. Alternatively, or additionally, the TCI state may indicate a common beam report configuration ID in each TCI state. A TCI pool may be configured for each BWP and/or each component carrier, and each TCI may indicate a same TCI ID that points to a same common RS transmit beam.

As shown by reference number 645, the network node 110 may transmit, and the UE 120 may receive, one or more RS(s). For instance, the network node may transmit one or more RS(s) that configured as a respective common RS transmit beam and/or as indicated in a TCI state.

As shown by reference number 650, the UE 120 may generate one or more beam measurement metrics, such as a beam measurement metric as indicated in a report configuration (e.g., a wideband RSRP and/or a wideband SINR). In generating the beam measurement metrics, the UE 120 may compute a respective measurement metric for each virtual resource associated with a linked RS resource in a linked RS resource set that is indicated as a linked CMR. The UE 120 may compute the respective measurement metric using the respective common RS transmit beam that is associated with the respective virtual resource.

The UE 120 may compute respective measurement metrics for an entirety of linked RS resources and/or an entirety of virtual resources included in a linked RS resource set, but return fewer measurement metrics than computed. For example, the UE 120 may compute N measurement metrics, and select M measurement metrics (M being a first integer that is smaller than N, N being a second integer) using one or more selection criteria. An example selection criterion may include selecting the highest measurement metrics. To illustrate, the respective measurement metrics may be a wideband RSRP metric, and the UE 120 may select the four measurement metrics that have the highest wideband RSRP values out of the entire set of measurement metrics.

As one example, the UE 120 may receive the RS resource set configuration 502 and the report configuration 504 as described with regard to FIG. 5A. Accordingly, the UE 120 may compute the measurement metrics based at least in part on using virtual resources that are based at least in part on linked RS resources in the indicated linked CMR. In the first example 500 shown by FIG. 5A, the linked CMR indicates, as the linked RS resource set, the first RS resource set that is associated with the first component carrier (e.g., Resource set A associated with CC1 and/or BWP1 in CC1) and the second RS resource set that is associated with the second component carrier (e.g., Resource set B associated with CC2 and/or BWP1 in CC2). In computing the measurement metrics, the UE 120 may use the respective common RS transmit beam associated with the linked RS resources (e.g., the virtual resources), and may select a subset of measurement metrics to transmit to the network node 110 as described above.

As a second example, the UE 120 may receive the RS resource set configuration 532 and the report configuration 534 as described with regard to FIG. 5B. Accordingly, the UE 120 may compute the measurement metrics based at least in part on using virtual resources that are based at least in part on linked RS resources in the linked RS resource set that have the RS resource set ID of Linkage=1 (e.g., Resource set A that is associated with CC1 and/or BWP1 in CC1 and Resource set B associated with CC2 and/or BWP1 in CC2). In computing the measurement metrics, the UE 120 may use the respective common RS transmit beam associated with the linked RS resources (e.g., the virtual resources), and may select a subset of measurement metrics to transmit to the network node 110 as described above.

As a third example, the UE 120 may receive the CBCC group configuration 562, the RS resource set configuration 564, and the report configuration 566 as described with regard to FIG. 5C. Accordingly, the UE 120 may compute the measurement metrics based at least in part on using virtual resources that are based at least in part on linked RS resources in RS resource set A that are assigned to component carriers in a same CBCC group (e.g., the first component carrier, CC1, and the second component carrier, CC2, that are included in the first CBCC group, Group 1). In computing the measurement metrics, the UE 120 may use the respective common RS transmit beam associated with the linked RS resources (e.g., the virtual resources), and may select a subset of measurement metrics to transmit to the network node 110 as described above.

As shown by reference number 655, the UE 120 may transmit, and the network node 110 may receive one or more beam reports. In some aspects, the UE 120 may transmit the beam report(s) in Layer 1 signaling (e.g., UCI), but other examples may include the UE 120 transmitting the beam report(s) Layer 2 signaling (e.g., a MAC CE), and/or in Layer 3 signaling (e.g., RRC signaling). A beam report may indicate a subset of measurement metrics computed by the UE 120 as described with regard to reference number 650. Alternatively, or additionally, the beam report may indicate a respective virtual resource ID that is associated with the respective measurement metric included in the beam report. That is, the beam report may indicate the respective virtual resource used to generate the respective measurement metric.

A network node may reduce a signaling overhead that is associated with beam reporting by a UE by configuring the UE to perform cross-component carrier joint beam reporting. To illustrate, the network node may indicate one or more RS resource linkage(s) that link RS resources, and/or one or more RS resource set linkages that link RS resource sets, that are associated with different component carriers. The network node may indicate the RS resource linkage(s) and/or the RS resource set linkage(s) by indicating combination of a CBCC group configuration, an RS resource set configuration, and/or a report configuration as described herein. The linked RS resources that are within linked RS resource sets may use respective common RS transmit beams, resulting in a reduced number of beam reports transmitted by the UE and, consequently, reduced signaling overhead. The reduced signaling overhead may increase an efficiency of air interface resource usage, increased data throughput, and/or reduced data transfer latencies.

As indicated above, FIG. 6 is provided as an example. Other examples may differ from what is described with regard to FIG. 6.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with cross-component carrier joint beam reporting.

As shown in FIG. 7, in some aspects, process 700 may include transmitting an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams (block 710). For example, the network node (e.g., using transmission component 904 and/or communication manager 906, depicted in FIG. 9) may transmit an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams, as described above.

As further shown in FIG. 7, in some aspects, process 700 may include transmitting a report configuration that indicates: an RS resource set linkage between the first RS resource set and the second RS resource set, and an instruction to perform cross-component carrier joint beam reporting based at least in part on the RS resource set linkage and the one or more common RS transmit beams (block 720). For example, the network node (e.g., using transmission component 904 and/or communication manager 906, depicted in FIG. 9) may transmit a report configuration that indicates: an RS resource set linkage between the first RS resource set and the second RS resource set, and an instruction to perform cross-component carrier joint beam reporting based at least in part on the RS resource set linkage and the one or more common RS transmit beams, as described above.

Process 700 may include additional aspects, such as any single aspect or any combination of aspects described below and/or in connection with one or more other processes described elsewhere herein.

In a first aspect, the first RS resource set is associated with a first BWP that is included in the first component carrier, the second RS resource set is associated with a second BWP that is included in the second component carrier, and the first RS resource set and the second RS resource set include a same quantity of RS resources.

In a second aspect, the RS resource set configuration indicates the respective RS resource linkage by indicating a same RS resource ID for the first respective RS resource and the second respective RS resource.

In a third aspect, the first respective RS resource and the second respective RS resource are both associated with the respective common RS transmit beam.

In a fourth aspect, the first respective RS resource and the second respective RS resource form a respective virtual resource based at least in part on the RS resource set linkage between the first RS resource set and the second RS resource set, and the RS resource linkage.

In a fifth aspect, the respective virtual resource is further based at least in part on the first component carrier associated with the first respective RS resource and the second respective RS resource both being in a same common beam component carrier group.

In a sixth aspect, the respective virtual resource is assigned a same RS resource identifier that is assigned to the first respective RS resource and the second respective RS resource.

In a seventh aspect, the report configuration indicates a reporting metric type to generate for a virtual resource that is associated with the RS resource set linkage.

In an eighth aspect, the report configuration indicates a reporting mode for the cross-component carrier joint beam reporting, the reporting mode including at least one of a periodic reporting mode, a semi-persistent reporting mode, an aperiodic reporting mode, or an event-triggered reporting mode.

In a ninth aspect, the instruction indicates to perform the cross-component carrier joint beam reporting based at least in part on N virtual resources, and process 700 includes receiving a report that includes M measurement metrics that are based at least in part on a subset of the N virtual resources, M being a first integer that is smaller than N, N being a second integer.

In a tenth aspect, process 700 includes transmitting a TCI ID that is associated with indicating the respective common RS transmit beam, and a TCI state associated with the TCI ID indicates, as a QCL RS, a wideband RS.

In an eleventh aspect, the TCI state indicates the QCL RS using at least one of a virtual resource identifier, or a common beam report configuration identifier.

In a twelfth aspect, the TCI state indicates the QCL RS using at least one of a respective RS resource identifier that is associated with the respective RS resource linkage and the respective common RS transmit beam, or a common beam report configuration identifier.

In a thirteenth aspect, the RS resource set configuration indicates the RS resource set linkage based at least in part on indicating a same RS resource set ID for the first RS resource set and the second RS resource set, and the report configuration indicates to perform the cross-component carrier joint beam reporting using the first RS resource set and the second RS resource set based at least in part on indicating the same RS resource set ID.

In a fourteenth aspect, process 700 includes transmitting a CBCC group configuration that indicates one or more CBCC groups, the CBCC group configuration indicating that the first component carrier and the second component carrier are included in a first CBCC group of the one or more CBCC groups.

In a fifteenth aspect, the first RS resource set and the second RS resource set include a same quantity of RS resources.

In a sixteenth aspect, the RS resource set configuration indicates the respective RS resource linkage by indicating a same RS resource ID for the first respective RS resource and the second respective RS resource.

In a seventeenth aspect, the RS resource set configuration indicates a same RS resource set ID for the first RS resource set and the second RS resource set in the first CBCC group, and the report configuration indicates to perform the cross-component carrier joint beam reporting using the first RS resource set and the second RS resource set in the first CBCC group based at least in part on indicating the same RS resource set ID.

In an eighteenth aspect, the respective RS resource linkage is based at least in part on the RS resource set configuration indicates by indicating a same RS resource ID for the first respective RS resource and the second respective RS resource, and the first component carrier associated with the first respective RS resource and the second respective RS resource both being in the first CBCC group.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with cross-component carrier joint beam reporting.

As shown in FIG. 8, in some aspects, process 800 may include receiving an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams (block 810). For example, the UE (e.g., using reception component 1002 and/or communication manager 1006, depicted in FIG. 10) may receive an RS resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams, as described above.

As further shown in FIG. 8, in some aspects, process 800 may include receiving a report configuration that indicates: an RS resource set linkage between the first RS resource set and the second RS resource set, and an instruction to perform cross-component carrier joint beam reporting based at least in part on the RS resource set linkage and the one or more common RS transmit beams (block 820). For example, the UE (e.g., using reception component 1002 and/or communication manager 1006, depicted in FIG. 10) may receive a report configuration that indicates: an RS resource set linkage between the first RS resource set and the second RS resource set, and an instruction to perform cross-component carrier joint beam reporting based at least in part on the RS resource set linkage and the one or more common RS transmit beams, as described above.

Process 800 may include additional aspects, such as any single aspect or any combination of aspects described below and/or in connection with one or more other processes described elsewhere herein.

In a first aspect, the first RS resource set is associated with a first BWP that is included in the first component carrier, the second RS resource set is associated with a second BWP that is included in the second component carrier, and the first RS resource set and the second RS resource set include a same quantity of RS resources.

In a second aspect, the RS resource set configuration indicates the respective RS resource linkage by indicating a same RS resource ID for the first respective RS resource and the second respective RS resource.

In a third aspect, the first respective RS resource and the second respective RS resource are both associated with the respective common RS transmit beam.

In a fourth aspect, the first respective RS resource and the second respective RS resource form a respective virtual resource based at least in part on the RS resource set linkage between the first RS resource set and the second RS resource set, and the RS resource linkage.

In a fifth aspect, the respective virtual resource is further based at least in part on the first component carrier associated with the first respective RS resource and the second respective RS resource both being in a same common beam component carrier group.

In a sixth aspect, the respective virtual resource is assigned a same RS resource identifier that is assigned to the first respective RS resource and the second respective RS resource.

In a seventh aspect, the report configuration indicates a reporting metric type to generate for a virtual resource that is associated with the RS resource set linkage.

In an eighth aspect, the report configuration indicates a reporting mode for the cross-component carrier joint beam reporting, the reporting mode including at least one of a periodic reporting mode, a semi-persistent reporting mode, an aperiodic reporting mode, or an event-triggered reporting mode.

In a ninth aspect, the instruction indicates to perform the cross-component carrier joint beam reporting based at least in part on N virtual resources, and process 800 includes transmitting a report that includes M measurement metrics that are based at least in part on a subset of the N virtual resources, M being a first integer that is smaller than N, N being a second integer.

In a tenth aspect, process 800 includes computing N measurement metrics that are based at least in part on the N virtual resources, and selecting the M measurement metrics from the N measurement metrics based at least in part on a selection criterion.

In an eleventh aspect, process 800 includes receiving a TCI ID that is associated with indicating the respective common RS transmit beam, and a TCI state associated with the TCI ID indicates, as a QCL RS, a wideband RS.

In a twelfth aspect, the TCI state indicates the QCL RS using at least one of a virtual resource identifier, or a common beam report configuration identifier.

In a thirteenth aspect, the TCI state indicates the QCL RS using at least one of a respective RS resource identifier that is associated with the respective RS resource linkage and the respective common RS transmit beam, or a common beam report configuration identifier.

In a fourteenth aspect, the RS resource set configuration indicates the RS resource set linkage based at least in part on indicating a same RS resource set ID for the first RS resource set and the second RS resource set, and the report configuration indicates to perform the cross-component carrier joint beam reporting using the first RS resource set and the second RS resource set based at least in part on indicating the same RS resource set ID.

In a fifteenth aspect, process 800 includes receiving a CBCC group configuration that indicates one or more CBCC groups, the CBCC group configuration indicating that the first component carrier and the second component carrier are included in a first CBCC group of the one or more CBCC groups.

In a sixteenth aspect, the first RS resource set and the second RS resource set include a same quantity of RS resources.

In a seventeenth aspect, the RS resource set configuration indicates the respective RS resource linkage by indicating a same RS resource ID for the first respective RS resource and the second respective RS resource.

In an eighteenth aspect, the RS resource set configuration indicates a same RS resource set ID for the first RS resource set and the second RS resource set in the first CBCC group, and the report configuration indicates to perform the cross-component carrier joint beam reporting using the first RS resource set and the second RS resource set in the first CBCC group based at least in part on indicating the same RS resource set ID.

In a nineteenth aspect, the respective RS resource linkage is based at least in part on the RS resource set configuration indicates by indicating a same RS resource ID for the first respective RS resource and the second respective RS resource, and the first component carrier associated with the first respective RS resource and the second respective RS resource both being in the first CBCC group.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit an RS resource set configuration that indicates one or more RS resource linkages between a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams. The transmission component 904 may transmit a report configuration that indicates an RS resource set linkage between the first RS resource set and the second RS resource set, and an instruction to perform cross-component carrier joint beam reporting based at least in part on the RS resource set linkage and the one or more common RS transmit beams.

The transmission component 904 may transmit a TCI ID that is associated with indicating the respective common RS transmit beam and a TCI state associated with the TCI ID indicates, as a QCL RS, a wideband RS. Alternatively, or additionally, the transmission component 904 may transmit a CBCC group configuration that indicates one or more CBCC groups, the CBCC group configuration indicating that the first component carrier and the second component carrier are included in a first CBCC group of the one or more CBCC groups.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an RS resource set configuration that indicates one or more RS resource linkages between a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams. The reception component 1002 may receive a report configuration that indicates an RS resource set linkage between the first RS resource set and the second RS resource set, and an instruction to perform cross-component carrier joint beam reporting based at least in part on the RS resource set linkage and the one or more common RS transmit beams.

The communication manager 1006 may compute N measurement metrics that are based at least in part on N virtual resources. In some aspects, the communication manager 1006 may select M measurement metrics from the N measurement metrics based at least in part on a selection criterion, M being a first integer that is smaller than N, N being a second integer.

The reception component 1002 may receive a TCI ID that is associated with indicating the respective common RS transmit beam and a TCI state associated with the TCI ID indicates, as a QCL RS, a wideband RS. Alternatively, or additionally, the reception component 1002 may receive a CBCC group configuration that indicates one or more CBCC groups, the CBCC group configuration indicating that the first component carrier and the second component carrier are included in a first CBCC group of the one or more CBCC groups.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a network node, comprising: transmitting a reference signal (RS) resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and transmitting a report configuration that indicates: an RS resource set linkage between the first RS resource set and the second RS resource set, and an instruction to perform cross-component carrier joint beam reporting based at least in part on the RS resource set linkage and the one or more common RS transmit beams.

Aspect 2: The method of Aspect 1, wherein the first RS resource set is associated with a first bandwidth part (BWP) that is included in the first component carrier, wherein the second RS resource set is associated with a second BWP that is included in the second component carrier, and wherein the first RS resource set and the second RS resource set include a same quantity of RS resources.

Aspect 3: The method of any of Aspects 1-2, wherein the RS resource set configuration indicates the respective RS resource linkage by indicating a same RS resource identifier (ID) for the first respective RS resource and the second respective RS resource.

Aspect 4: The method of Aspect 3, wherein the first respective RS resource and the second respective RS resource are both associated with the respective common RS transmit beam.

Aspect 5: The method of any of Aspects 1-4, wherein the first respective RS resource and the second respective RS resource form a respective virtual resource based at least in part on: the RS resource set linkage between the first RS resource set and the second RS resource set, and the RS resource linkage.

Aspect 6: The method of Aspect 5, wherein the respective virtual resource is further based at least in part on the first component carrier associated with the first respective RS resource and the second respective RS resource both being in a same common beam component carrier group.

Aspect 7: The method of Aspect 5 or Aspect 6, wherein the respective virtual resource is assigned a same RS resource identifier that is assigned to the first respective RS resource and the second respective RS resource.

Aspect 8: The method of any of Aspects 1-7, wherein the report configuration indicates a reporting metric type to generate for a virtual resource that is associated with the RS resource set linkage.

Aspect 9: The method of any of Aspects 1-8, wherein the report configuration indicates a reporting mode for the cross-component carrier joint beam reporting, the reporting mode comprising at least one of: a periodic reporting mode, a semi-persistent reporting mode, an aperiodic reporting mode, or an event-triggered reporting mode.

Aspect 10: The method of any of Aspects 1-9, wherein the instruction indicates to perform the cross-component carrier joint beam reporting based at least in part on N virtual resources, and wherein the method further comprises: receiving a report that includes M measurement metrics that are based at least in part on a subset of the N virtual resources, M being a first integer that is smaller than N, N being a second integer.

Aspect 11: The method of any of Aspects 1-10, further comprising: transmitting a transmission configuration indicator (TCI) identifier (ID) that is associated with indicating the respective common RS transmit beam, wherein a TCI state associated with the TCI ID indicates, as a quasi-co-located (QCL) RS, a wideband RS.

Aspect 12: The method of Aspect 11, wherein the TCI state indicates the QCL RS using at least one of: a virtual resource identifier, or a common beam report configuration identifier.

Aspect 13: The method of Aspect 11, wherein the TCI state indicates the QCL RS using at least one of: a respective RS resource identifier that is associated with the respective RS resource linkage and the respective common RS transmit beam, or a common beam report configuration identifier.

Aspect 14: The method of any of Aspects 1-13, wherein the RS resource set configuration indicates the RS resource set linkage based at least in part on indicating a same RS resource set identifier (ID) for the first RS resource set and the second RS resource set, and wherein the report configuration indicates to perform the cross-component carrier joint beam reporting using the first RS resource set and the second RS resource set based at least in part on indicating the same RS resource set ID.

Aspect 15: The method of any of Aspects 1-14, further comprising: transmitting a common beam component carrier (CBCC) group configuration that indicates one or more CBCC groups, the CBCC group configuration indicating that the first component carrier and the second component carrier are included in a first CBCC group of the one or more CBCC groups.

Aspect 16: The method of Aspect 15, wherein the first RS resource set and the second RS resource set include a same quantity of RS resources.

Aspect 17: The method of Aspect 15 or Aspect 16, wherein the RS resource set configuration indicates the respective RS resource linkage by indicating a same RS resource identifier (ID) for the first respective RS resource and the second respective RS resource.

Aspect 18: The method of any one of Aspects 15-17, wherein the RS resource set configuration indicates a same RS resource set identifier (ID) for the first RS resource set and the second RS resource set in the first CBCC group, and wherein the report configuration indicates to perform the cross-component carrier joint beam reporting using the first RS resource set and the second RS resource set in the first CBCC group based at least in part on indicating the same RS resource set ID.

Aspect 19: The method any one of Aspects 15-18, wherein the respective RS resource linkage is based at least in part on: the RS resource set configuration indicates by indicating a same RS resource identifier (ID) for the first respective RS resource and the second respective RS resource, and the first component carrier associated with the first respective RS resource and the second respective RS resource both being in the first CBCC group.

Aspect 20: A method of wireless communication performed by a user equipment (UE), comprising: receiving a reference signal (RS) resource set configuration that indicates one or more RS resource linkages between: a first RS resource set that is associated with a first component carrier, and a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and receiving a report configuration that indicates: an RS resource set linkage between the first RS resource set and the second RS resource set, and an instruction to perform cross-component carrier joint beam reporting based at least in part on the RS resource set linkage and the one or more common RS transmit beams.

Aspect 21: The method of Aspect 20, wherein the first RS resource set is associated with a first bandwidth part (BWP) that is included in the first component carrier, wherein the second RS resource set is associated with a second BWP that is included in the second component carrier, and wherein the first RS resource set and the second RS resource set include a same quantity of RS resources.

Aspect 22: The method of any of Aspects 20-21, wherein the RS resource set configuration indicates the respective RS resource linkage by indicating a same RS resource identifier (ID) for the first respective RS resource and the second respective RS resource.

Aspect 23: The method of Aspect 22, wherein the first respective RS resource and the second respective RS resource are both associated with the respective common RS transmit beam.

Aspect 24: The method of any of Aspects 20-23, wherein the first respective RS resource and the second respective RS resource form a respective virtual resource based at least in part on: the RS resource set linkage between the first RS resource set and the second RS resource set, and the RS resource linkage.

Aspect 25: The method of Aspect 24, wherein the respective virtual resource is further based at least in part on the first component carrier associated with the first respective RS resource and the second respective RS resource both being in a same common beam component carrier group.

Aspect 26: The method of Aspect 24 or Aspect 25, wherein the respective virtual resource is assigned a same RS resource identifier that is assigned to the first respective RS resource and the second respective RS resource.

Aspect 27: The method of any of Aspects 20-26, wherein the report configuration indicates a reporting metric type to generate for a virtual resource that is associated with the RS resource set linkage.

Aspect 28: The method of any of Aspects 20-27, wherein the report configuration indicates a reporting mode for the cross-component carrier joint beam reporting, the reporting mode comprising at least one of: a periodic reporting mode, a semi-persistent reporting mode, an aperiodic reporting mode, or an event-triggered reporting mode.

Aspect 29: The method of any of Aspects 20-28, wherein the instruction indicates to perform the cross-component carrier joint beam reporting based at least in part on N virtual resources, and wherein the method further comprises: transmitting a report that includes M measurement metrics that are based at least in part on a subset of the N virtual resources, M being a first integer that is smaller than N, N being a second integer.

Aspect 30: The method of Aspect 29, further comprising: computing N measurement metrics that are based at least in part on the N virtual resources; and selecting the M measurement metrics from the N measurement metrics based at least in part on a selection criterion.

Aspect 31: The method of any of Aspects 20-30, further comprising: receiving a transmission configuration indicator (TCI) identifier (ID) that is associated with indicating the respective common RS transmit beam, wherein a TCI state associated with the TCI ID indicates, as a quasi-co-located (QCL) RS, a wideband RS.

Aspect 32: The method of Aspect 31, wherein the TCI state indicates the QCL RS using at least one of: a virtual resource identifier, or a common beam report configuration identifier.

Aspect 33: The method of Aspect 31 or Aspect 32, wherein the TCI state indicates the QCL RS using at least one of: a respective RS resource identifier that is associated with the respective RS resource linkage and the respective common RS transmit beam, or a common beam report configuration identifier.

Aspect 34: The method of any of Aspects 20-33, wherein the RS resource set configuration indicates the RS resource set linkage based at least in part on indicating a same RS resource set identifier (ID) for the first RS resource set and the second RS resource set, and wherein the report configuration indicates to perform the cross-component carrier joint beam reporting using the first RS resource set and the second RS resource set based at least in part on indicating the same RS resource set ID.

Aspect 35: The method of any of Aspects 20-34, further comprising: receiving a common beam component carrier (CBCC) group configuration that indicates one or more CBCC groups, the CBCC group configuration indicating that the first component carrier and the second component carrier are included in a first CBCC group of the one or more CBCC groups.

Aspect 36: The method of Aspect 35, wherein the first RS resource set and the second RS resource set include a same quantity of RS resources.

Aspect 37: The method of Aspect 35 or Aspect 36, wherein the RS resource set configuration indicates the respective RS resource linkage by indicating a same RS resource identifier (ID) for the first respective RS resource and the second respective RS resource.

Aspect 38: The method of any one of Aspects 35-37, wherein the RS resource set configuration indicates a same RS resource set identifier (ID) for the first RS resource set and the second RS resource set in the first CBCC group, and wherein the report configuration indicates to perform the cross-component carrier joint beam reporting using the first RS resource set and the second RS resource set in the first CBCC group based at least in part on indicating the same RS resource set ID.

Aspect 39: The method of any one of Aspect 35-38, wherein the respective RS resource linkage is based at least in part on: the RS resource set configuration indicates by indicating a same RS resource identifier (ID) for the first respective RS resource and the second respective RS resource, and the first component carrier associated with the first respective RS resource and the second respective RS resource both being in the first CBCC group.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 41: An apparatus for wireless communication at a device, the apparatus comprising one or more memories and one or more processors coupled to the one or more memories, the one or more processors configured to cause the device to perform the method of one or more of Aspects 1-19.

Aspect 42: An apparatus for wireless communication, the apparatus comprising at least one means for performing the method of one or more of Aspects 1-19.

Aspect 43: A non-transitory computer-readable medium storing code for wireless communication, the code comprising instructions executable by one or more processors to perform the method of one or more of Aspects 1-19.

Aspect 44: A non-transitory computer-readable medium storing a set of instructions for wireless communication, the set of instructions comprising one or more instructions that, when executed by one or more processors of a device, cause the device to perform the method of one or more of Aspects 1-19.

Aspect 45: A device for wireless communication, the device comprising a processing system that includes one or more processors and one or more memories coupled with the one or more processors, the processing system configured to cause the device to perform the method of one or more of Aspects 1-19.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-19.

Aspect 47: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 20-39.

Aspect 48: An apparatus for wireless communication at a device, the apparatus comprising one or more memories and one or more processors coupled to the one or more memories, the one or more processors configured to cause the device to perform the method of one or more of Aspects 20-39.

Aspect 49: An apparatus for wireless communication, the apparatus comprising at least one means for performing the method of one or more of Aspects 20-39.

Aspect 50: A non-transitory computer-readable medium storing code for wireless communication, the code comprising instructions executable by one or more processors to perform the method of one or more of Aspects 20-39.

Aspect 51: A non-transitory computer-readable medium storing a set of instructions for wireless communication, the set of instructions comprising one or more instructions that, when executed by one or more processors of a device, cause the device to perform the method of one or more of Aspects 20-39.

Aspect 52: A device for wireless communication, the device comprising a processing system that includes one or more processors and one or more memories coupled with the one or more processors, the processing system configured to cause the device to perform the method of one or more of Aspects 20-39.

Aspect 53: An apparatus for wireless communication at a device, the apparatus comprising one or more memories and one or more processors coupled to the one or more memories, the one or more processors individually or collectively configured to cause the device to perform the method of one or more of Aspects 20-39.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a network node, comprising:
one or more memories; and
one or more processors coupled to the one or more memories, the one or more processors, individually or collectively, configured to cause the network node to:
transmit a reference signal (RS) resource set configuration that indicates one or more RS resource linkages between:
a first RS resource set that is associated with a first component carrier, and
a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and
transmit a report configuration that indicates:
an RS resource set linkage between the first RS resource set and the second RS resource set, and
an instruction to perform cross-component carrier joint beam reporting based at least in part on the RS resource set linkage and the one or more common RS transmit beams.

2. The apparatus of claim 1, wherein the first RS resource set is associated with a first bandwidth part (BWP) that is included in the first component carrier,
wherein the second RS resource set is associated with a second BWP that is included in the second component carrier, and
wherein the first RS resource set and the second RS resource set include a same quantity of RS resources.

3. The apparatus of claim 1, wherein the RS resource set configuration indicates the respective RS resource linkage by indicating a same RS resource identifier (ID) for the first respective RS resource and the second respective RS resource.

4. The apparatus of claim 1, wherein the first respective RS resource and the second respective RS resource form a respective virtual resource based at least in part on:
the RS resource set linkage between the first RS resource set and the second RS resource set, and
the RS resource linkage.

5. The apparatus of claim 4, wherein the respective virtual resource is further based at least in part on the first component carrier associated with the first respective RS resource and the second respective RS resource both being in a same common beam component carrier group.

6. The apparatus of claim 1, wherein the report configuration indicates a reporting metric type to generate for a virtual resource that is associated with the RS resource set linkage.

7. The apparatus of claim 1, wherein the report configuration indicates a reporting mode for the cross-component carrier joint beam reporting, the reporting mode comprising at least one of:
a periodic reporting mode,
a semi-persistent reporting mode,
an aperiodic reporting mode, or
an event-triggered reporting mode.

8. The apparatus of claim 1, wherein the one or more processors are further configured to cause the network node to:
transmit a transmission configuration indicator (TCI) identifier (ID) that is associated with indicating the respective common RS transmit beam,
wherein a TCI state associated with the TCI ID indicates, as a quasi-co-located (QCL) RS, a wideband RS.

9. The apparatus of claim 1, wherein the RS resource set configuration indicates the RS resource set linkage based at least in part on indicating a same RS resource set identifier (ID) for the first RS resource set and the second RS resource set, and
wherein the report configuration indicates to perform the cross-component carrier joint beam reporting using the first RS resource set and the second RS resource set based at least in part on indicating the same RS resource set ID.

10. The apparatus of claim 1, wherein the one or more processors are further configured to cause the network node to:
transmit a common beam component carrier (CBCC) group configuration that indicates one or more CBCC groups, the CBCC group configuration indicating that the first component carrier and the second component carrier are included in a first CBCC group of the one or more CBCC groups.

11. The apparatus of claim 10, wherein the RS resource set configuration indicates a same RS resource set identifier (ID) for the first RS resource set and the second RS resource set in the first CBCC group, and
wherein the report configuration indicates to perform the cross-component carrier joint beam reporting using the first RS resource set and the second RS resource set in the first CBCC group based at least in part on indicating the same RS resource set ID.

12. An apparatus for wireless communication at a user equipment (UE), comprising:
one or more memories; and
one or more processors coupled to the one or more memories, the one or more processors, individually or collectively, configured to cause the UE to:
receive a reference signal (RS) resource set configuration that indicates one or more RS resource linkages between:
a first RS resource set that is associated with a first component carrier, and
a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and
receive a report configuration that indicates:
an RS resource set linkage between the first RS resource set and the second RS resource set, and
an instruction to perform cross-component carrier joint beam reporting based at least in part on the RS resource set linkage and the one or more common RS transmit beams.

13. The apparatus of claim 12, wherein the first RS resource set is associated with a first bandwidth part (BWP) that is included in the first component carrier,
wherein the second RS resource set is associated with a second BWP that is included in the second component carrier, and
wherein the first RS resource set and the second RS resource set include a same quantity of RS resources.

14. The apparatus of claim 12, wherein the RS resource set configuration indicates the respective RS resource linkage by indicating a same RS resource identifier (ID) for the first respective RS resource and the second respective RS resource.

15. The apparatus of claim 12, wherein the first respective RS resource and the second respective RS resource form a respective virtual resource based at least in part on:
the RS resource set linkage between the first RS resource set and the second RS resource set, and
the RS resource linkage.

16. The apparatus of claim 12, wherein the instruction indicates to perform the cross-component carrier joint beam reporting based at least in part on N virtual resources, and
wherein the one or more processors are further configured to cause the UE to:
transmit a report that includes M measurement metrics that are based at least in part on a subset of the N virtual resources, M being a first integer that is smaller than N, N being a second integer.

17. The apparatus of claim 16, wherein the one or more processors are further configured to cause the UE to:
compute N measurement metrics that are based at least in part on the N virtual resources; and
select the M measurement metrics from the N measurement metrics based at least in part on a selection criterion.

18. The apparatus of claim 12, wherein the one or more processors are further configured to cause the UE to:
receive a transmission configuration indicator (TCI) identifier (ID) that is associated with indicating the respective common RS transmit beam,
wherein a TCI state associated with the TCI ID indicates, as a quasi-co-located (QCL) RS, a wideband RS.

19. The apparatus of claim 12, wherein the RS resource set configuration indicates the RS resource set linkage based at least in part on indicating a same RS resource set identifier (ID) for the first RS resource set and the second RS resource set, and
wherein the report configuration indicates to perform the cross-component carrier joint beam reporting using the first RS resource set and the second RS resource set based at least in part on indicating the same RS resource set ID.

20. The apparatus of claim 12, wherein the one or more processors are further configured to cause the UE to:
receive a common beam component carrier (CBCC) group configuration that indicates one or more CBCC groups, the CBCC group configuration indicating that the first component carrier and the second component carrier are included in a first CBCC group of the one or more CBCC groups.

21. The apparatus of claim 20, wherein the RS resource set configuration indicates a same RS resource set identifier (ID) for the first RS resource set and the second RS resource set in the first CBCC group, and
wherein the report configuration indicates to perform the cross-component carrier joint beam reporting using the first RS resource set and the second RS resource set in the first CBCC group based at least in part on indicating the same RS resource set ID.

22. A method of wireless communication performed by a network node, comprising:
transmitting a reference signal (RS) resource set configuration that indicates one or more RS resource linkages between:
a first RS resource set that is associated with a first component carrier, and
a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and
transmitting a report configuration that indicates:
an RS resource set linkage between the first RS resource set and the second RS resource set, and
an instruction to perform cross-component carrier joint beam reporting based at least in part on the RS resource set linkage and the one or more common RS transmit beams.

23. The method of claim 22, wherein the first RS resource set is associated with a first bandwidth part (BWP) that is included in the first component carrier,
wherein the second RS resource set is associated with a second BWP that is included in the second component carrier, and
wherein the first RS resource set and the second RS resource set include a same quantity of RS resources.

24. The method of claim 22, wherein the first respective RS resource and the second respective RS resource form a respective virtual resource based at least in part on:
the RS resource set linkage between the first RS resource set and the second RS resource set, and
the RS resource linkage.

25. The method of claim 22, wherein the instruction indicates to perform the cross-component carrier joint beam reporting based at least in part on N virtual resources, and wherein the method further comprises:
receiving a report that includes M measurement metrics that are based at least in part on a subset of the N virtual resources, M being a first integer that is smaller than N, N being a second integer.

26. The method of claim 22, further comprising:
transmitting a transmission configuration indicator (TCI) identifier (ID) that is associated with indicating the respective common RS transmit beam,
wherein a TCI state associated with the TCI ID indicates, as a quasi-co-located (QCL) RS, a wideband RS.

27. A method of wireless communication performed by a user equipment (UE), comprising:
receiving a reference signal (RS) resource set configuration that indicates one or more RS resource linkages between:
a first RS resource set that is associated with a first component carrier, and
a second RS resource set that is associated with a second component carrier, a respective RS resource linkage of the one or more RS resource linkages indicating an association between at least a first respective RS resource in the first RS resource set and a second respective RS resource in the second RS resource set, the respective RS resource linkage being associated with a respective common RS transmit beam of one or more common RS transmit beams; and
receiving a report configuration that indicates:
an RS resource set linkage between the first RS resource set and the second RS resource set, and
an instruction to perform cross-component carrier joint beam reporting based at least in part on the RS resource set linkage and the one or more common RS transmit beams.

28. The method of claim 27, wherein the first respective RS resource and the second respective RS resource form a respective virtual resource based at least in part on:
the RS resource set linkage between the first RS resource set and the second RS resource set, and
the RS resource linkage.

29. The method of claim 27, further comprising:
receiving a transmission configuration indicator (TCI) identifier (ID) that is associated with indicating the respective common RS transmit beam,
wherein a TCI state associated with the TCI ID indicates, as a quasi-co-located (QCL) RS, a wideband RS.

30. The method of claim 27, further comprising:
receiving a common beam component carrier (CBCC) group configuration that indicates one or more CBCC groups, the CBCC group configuration indicating that the first component carrier and the second component carrier are included in a first CBCC group of the one or more CBCC groups,
wherein the RS resource set configuration indicates a same RS resource set identifier (ID) for the first RS resource set and the second RS resource set in the first CBCC group, and
wherein the report configuration indicates to perform the cross-component carrier joint beam reporting using the first RS resource set and the second RS resource set in the first CBCC group based at least in part on indicating the same RS resource set ID.
